(19) United States
(12) Patent Application Publication
(10) Pub. No.: US 2022/0032247 A1
(43) Pub. Date: Feb. 3, 2022

(54) MICROFLUIDIC DEVICES

(71) Applicant: GLAXOSMITHKLINE BIOLOGICALS SA, Rixensart (BE)

(72) Inventors: Wilfred BUESINK, Rixensart (BE); Philippe JEHOULOT, Rixensart (BE); Amedeo MENAFRO, Siena (IT); Laurent Bernard Jean STRODIOT, Rixensart (BE); Emanuele TOMBA, Siena (IT)

(73) Assignee: GLAXOSMITHKLINE BIOLOGICALS SA, Rixensart (BE)

(21) Appl. No.: 17/299,043

(22) PCT Filed: Dec. 4, 2019
(86) PCT No.: PCT/EP2019/083758

§ 371 Date: Jun. 2, 2021

(30) Foreign Application Priority Data
Dec. 6, 2018 (EP) 18210865.4

(51) Int. Cl. B01F 13/00; B01F 5/06

(52) U.S. Cl. CPC B01F 13/0064; B01F 2215/0431; B01F 5/0602

(57) ABSTRACT

The present invention relates broadly to microfluidic devices, particularly microfluidic devices optimised for the industrial production of nanoparticles such as liposomes. The device (101) comprises a substrate which extends between a distal end (107) comprising an outlet region (105) and a proximal end (108) comprising an inlet region (106). The inlet region comprises two substantially parallel outer channels (103a, 103b) for transport of a first fluid, said outer channels (103a, 103b) defined in part by a first outer wall (109a) and a second outer wall (109b) respectively, and a linear inner channel (104) for transport of a second fluid. The linear channel is disposed between the two substantially parallel outer channels. The outer channels (103a, 103b) and inner channel (104) extend from the proximal end (108) to a mixing chamber (102) which extends from the inlet region (106) to the outlet region (105). The mixing chamber (102) is in flow communication with the inner and outer channels (103a, 103b, 104) to receive the first and second fluids from the inner and outer channels (103a, 103b, 104) and the mixing chamber (102) has a uniform width (W) along its length substantially equal to the width (W1) between the outer walls (109a, 109b) of the two substantially parallel outer channels (103a, 103b).

### FIELD OF THE INVENTION

The present invention relates broadly to microfluidic devices, particularly microfluidic devices optimised for the industrial production of nanoparticles such as liposomes.

### BACKGROUND TO THE INVENTION

Microfluidic devices may be used for mixing small volumes of fluids thereby conserving precious materials. However, they have generally been used in research environments to prepare small amounts of product.

In order to find utility in an industrial production setting, there is a need for low cost microfluidic devices that simplify and ease manufacturing processes. In addition, for pharmaceutical purposes, such devices will need to be able to generate nanoparticles at high throughput whilst maintaining a monodisperse in size distribution. International patent application PCT/EP2018/057488 (published as WO2018219521) discloses microfluidic devices comprising a mixing chamber which is rectangular in cross-section, having a long side of 2 mm, a short side of 4 mm, one serpentine inlet of 0.4 mm by 2 mm for a first solution and two inlets of 0.4 mm by 2 mm for a second solution which are symmetrically disposed at the proximal end of the mixing chamber, a mixing chamber length of 2.5 cm and an outlet located at the distal end of the mixing chamber. EP1992403 discloses devices having enlarged chambers that promote side to side oscillation of a jet of liquid for mixing. EP2596858 discloses microfluidic devices for the formation of aqueous droplets in a continuous phase without mixing of the aqueous and continuous phases. However, there exists a need for further microfluidic devices optimised for industrial production of nanoparticles.

### SUMMARY OF THE INVENTION

The invention provides microfluidic devices comprising a mixing chamber having a distal end comprising an outlet region and a proximal end comprising an inlet region, the inlet region comprising two substantially parallel outer channels configured for transport of a first fluid and an inner channel configured for transport of a second fluid, wherein the inner channel is disposed between the two substantially parallel outer channels, and wherein the mixing chamber is configured to receive the first and second fluids from the inner and outer channels.

In accordance with a first aspect of the invention, there is provided, a microfluidic device wherein the inner channel is linear.

In accordance with a second aspect of the invention, there is provided, a microfluidic device wherein the channels and mixing chamber have a depth of greater than 400 um.

In accordance with a third aspect of the invention, there is provided, a microfluidic device wherein the width of the two substantially parallel outer channels is greater than 200 um.

In accordance with a fourth aspect of the invention, there is provided, a microfluidic device wherein the width of the two substantially parallel outer channels is less than 200 um.

In accordance with a fifth aspect of the invention, there is provided, a microfluidic device wherein the width of the inner channel is greater than 200 um.

In accordance with a sixth aspect of the invention, there is provided, a microfluidic device wherein the width of the inner channel is less than 200 um.

In accordance with a seventh aspect of the invention, there is provided, a microfluidic device wherein the mixing chamber has a length of greater than 25 mm. In accordance with a eight aspect of the invention, there is provided, a microfluidic device wherein the mixing chamber has a width of less than 2000 um.

In accordance with a ninth aspect of the invention, there is provided, a microfluidic device wherein the mixing chamber is tapered along its length.

In accordance with a tenth aspect of the invention, there is provided, a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, and wherein the mixing chamber is configured to receive the first and second fluids from the inner and outer channels.

In an eleventh aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the channels and mixing chamber have a depth of greater than about 400 pm, particularly about 500 μm.

In a twelfth aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the width of the two substantially parallel outer channels is about 400 μm or less, particularly about 200 μm or less, more particularly about 150 μm or less, yet more particularly about 100 μm. The two substantially parallel outer channels may each have a width of from about 100 μm to about 400 μm, for example, about 200 μm or about 150 μm. The two substantially parallel outer channels comprise first and second ends, the first ends being in fluid communication with a source of a first fluid, for example via an inlet, and the second ends in fluid communication with the mixing chamber. Preferably the two substantially parallel outer channels are aligned parallel, to the general direction of flow through the mixing chamber. In preferred embodiments, the two substantially parallel outer channels share a common inlet, in other words, the first ends of each of the two outer channels are in fluid communication. In other embodiments, the two substantially parallel outer channels have separate inlets in fluid communication with a source of the first fluid.

In a thirteenth aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the width of the linear inner channel is about 400 μm or less, particularly about 270 μm or less, more particularly about 230 μm or less, yet more particularly about 200 μm. The linear inner channel may have a width of from about 200 μm to about 400 μm, for example, about 400 μm, about 270 μm or about 230 μm. Particularly the linear fluid channel has a first end and a second end, the first end being in fluid communication with a source of a second fluid, for example via an inlet, and the second end in fluid communication with the mixing chamber. Preferably the linear fluid channel is aligned parallel to the general direction of flow through the mixing chamber. In preferred embodiments, the inner channel is disposed or positioned between the two substantially parallel outer channels. Particularly, the inner channel is disposed or positioned equidistant between the two substantially parallel outer channels. In certain embodiments, the inner channel is parallel with the two outer channels.

In a fifteenth aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the width of the linear inner channel is greater than 400 μm, particularly about 700 μm or greater, more particularly about 630 μm or greater, yet more particularly about 770 μm, for example between from about 630 μm to about 770 μm.

In a sixteenth aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the mixing chamber has a length of from about 25 mm to about 50 mm.

In a seventeenth aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the mixing chamber has a width of about 2000 μm or less, about 1800 μm or less, about 1600 μm or less or about 1000 μm.

In an eighteenth aspect of the invention, there is provided a microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the mixing chamber is tapered and has a width that decreases along its length from about 1600 μm to about 500 μm. In some embodiments, the mixing chamber tapers inwardly along at least a portion of its length from the distal end to the proximal end. The distal end of the mixing chamber may have a width of about 2000 μm, about 1800 μm, about 1600 μm, about 1500 μm, about 1400 μm, about 1300 μm, about 1200 μm, about 1100 μm or about 1000 μm. The proximal end of the mixing chamber may have a width of about 500 μm. In other embodiments, the mixing chamber has a uniform width from the distal end to the proximal end, for example, a width of about 2000 μm, about 1800 μm, about 1600 μm, about 1500 μm, about 1400 μm, about 1300 μm, about 1200 μm, about 1100 μm or about 1000 μm. Particularly, the mixing chamber has a length of from about 25 mm to about 50 mm.

In a nineteenth aspect of the invention, there is provided microfluidic device (101) comprising a substrate which extends between a distal end (107) comprising an outlet region (105) and a proximal end (108) comprising an inlet region (106), wherein the inlet region comprises two substantially parallel outer channels (103a, 103b) for transport of a first fluid, said outer channels (103a,103b) defined in part by a first outer wall (109a) and a second outer wall (109b) respectively, and a linear inner channel (104) for transport of a second fluid, wherein the linear channel is disposed between the two substantially parallel outer channels, wherein the outer channels (103a,103b) and inner channel (104) extend from the proximal end (108) to a mixing chamber (102) which extends from the inlet region (106) to the outlet region (105), wherein the mixing chamber (102) is in flow communication with the inner and outer channels (103a,103b,104) to receive the first and second fluids from the inner and outer channels (103a,103b,104) and wherein the mixing chamber (102) has a uniform width (W) along its length substantially equal to the width (W1) between the outer walls (109a, 109b) of the two substantially parallel outer channels (103a,103b). Particularly, the mixing chamber (102) is defined in part by a first outer wall (109c) and a second outer wall (109d) which are continuous with the respective outer walls (109a, 109b) of the two substantially parallel outer channels (103a, 103b). More particularly, the parallel channel outer walls (109a, 109b) and mixing chamber outer walls (109c, 109d) are provided by a first (109a,109c) and second wall (109b, 109d) which extend substantially the whole length of the device (101) between the proximal end (106) and distal end (107), and said first and second wall are linear and parallel with each other along substantially the whole length of the microfluidic chip. Still yet more particularly, the width of the linear inner channel is about 400 μm or less, particularly about 270 μm or less, more particularly about 230 μm or less, yet more particularly about 200 μm. The linear inner channel may have a width of from about 200 μm to about 400 μm, for example, about 400 μm, about 270 μm or about 230 μm. Even more particularly, the mixing chamber has a length of from about 25 mm to about 50 mm, preferably about 25 mm or about 50 mm. Particularly, the mixing chamber has a width of about 2000 μm or less, about 1800 μm or less, about 1600 μm or less or about 1000 μm. More particularly, the width of the two substantially parallel outer channels is about 400 μm or less, particularly about 200 μm or less, more particularly about 150 μm or less, yet more particularly about 100 μm. The two substantially parallel outer channels may each have a width of from about 100 μm to about 400 μm, for example, about 200 μm or about 150 μm.

In a twentieth aspect of the invention, there is provided a method of forming at least one nanoparticle using the microfluidic device of any aspect of the invention, including the first, second, third, fourth, fifth, sixth, seventh or eighth aspects. In a twenty-first aspect of the invention, there is provided a chip comprising a microfluidic device of any aspect of the invention, including the first, second, third, fourth, fifth, sixth, seventh, eighth or ninth aspect of the invention.

Further aspects of the invention may combine features of any aspect of the invention, including the first, second, third, fourth, fifth, sixth, seventh, eighth, ninth, tenth, eleventh, twelfth, thirteenth, fourteenth, fifteenth, sixteenth, seventeenth, eighteenth, nineteenth, twentieth and twenty-first aspects.

### DESCRIPTION OF DRAWINGS/FIGURES

FIG. 1 is a schematic drawing showing a generalized microfluidic device of the invention.

FIG. 2 is a schematic drawing showing five different implementations (A to E) of the inlet region of the microfluidic device. In implementations C and E, the first ends of each of the two outer channels are continuous with one another and share a common inlet.

FIG. 3 is a schematic drawing showing two different implementations (A and B) of the mixing chamber of the microfluidic devices. Implementation B comprises tapered walls.

FIG. 4 provides the architecture of a microfluidic device of the invention comprising a silicon layer with a glass cover layer.

FIG. 5 provides a magnified view of part A from FIG. 4 showing the interface between the inlet channels and the mixing chamber.

FIG. 6 provides schematics of embodiments of Table 1 that are produced with channels having either a depth of 400 μm or 500 μm.

FIG. 7 provides schematics of embodiments of Table 1 having a mixing chamber length of about 50 mm and which are produced with channels having either a depth of 400 μm or 500 μm.

FIG. 8 Computational fluid dynamics simulations to investigate the impact of the central channel on fluid flow. Replacing the serpentine channel with a linear central channel has no impact on fluid flow or mixing.

FIG. 9 Results of the computation fluid dynamics (CFD) simulations for each of the designs referred to in Example 2 using the same flow rate and ratio (total 16 ml/min, 4:1 External/Internal channel).

FIG. 10 Comparison of the mixing performance for each design referred to in Example 2 (Note that the lines for designs 1 and 2 overlay precisely). The x axis corresponds to the ratio between the length of the central channel and the length of the mixing chamber to enable the different designs to be compared.

FIG. 11 Final mixing coefficient (Alpha) was determined for each of the 19 different designs referred to in Example 3. The width of the mixing chamber (MC) was either 1 mm, 2 mm or 3 mm; the width of the internal linear channel (CapInt) was either 0.1 mm, 0.2 mm or 0.3 mm; the width of the external channels (CapExt) was either 0.1 mm, 0.2 mm or 0.3 mm. The highest value of alpha, i.e. best mixing performance, was obtained using a microfluidic device having a mixing chamber width of 1 mm, external channel width of 0.1 mm and internal channel width of 0.2 mm.

FIG. 12 Comparison of the mixing profile of the modified geometries versus design 1 (from PCT/EP2018/057488).

FIG. 13 Provides results relating to the impact on channel depth was investigated using four different depths: 0.4 mm, 0.5 mm, 0.6 mm and 0.675 mm.

FIG. 14 Provides an overview of the results (size and PDI) obtained for each microchip design referred to in Example 6.

### DETAILED DESCRIPTION OF THE INVENTION

The inventors have developed new microfluidic devices with optimised channel geometries, particularly for the preparation of lipid containing nanoparticles. The microfluidic devices of the present invention enable high throughput production of lipid containing particles at an industrial scale. In addition, the devices are capable of producing lipid containing particles that are monodisperse in size distribution, for example, having a low polydispersity index. The term “microfluidic device” refers to a device with at least one channel having micron-scale dimensions (i.e., a dimension less than 1 mm) for manipulating (e.g., flowing, mixing, etc.) a fluid sample. Microfluidic devices of the present invention are passive devices, containing no moving parts and having no requirement for energy input other than the pressure used to drive fluid flow through the device at a constant rate. The term “nanoparticles” is defined as a substantially homogeneous particle comprising more than one component material, particularly a lipid such as a cationic lipid, and having a smallest dimension that is less than 350 nanometers.

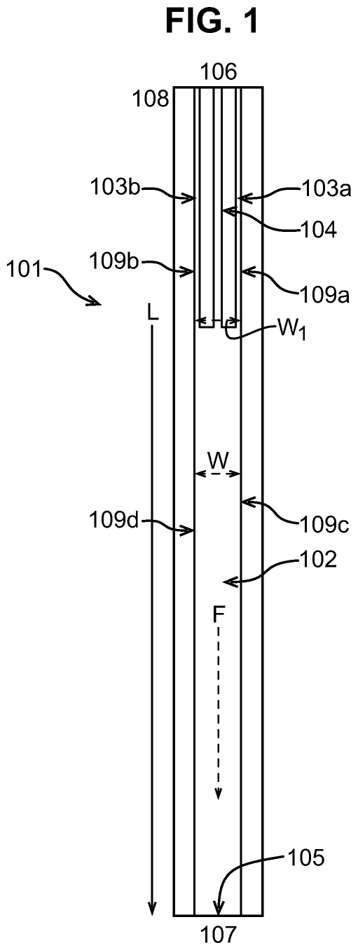

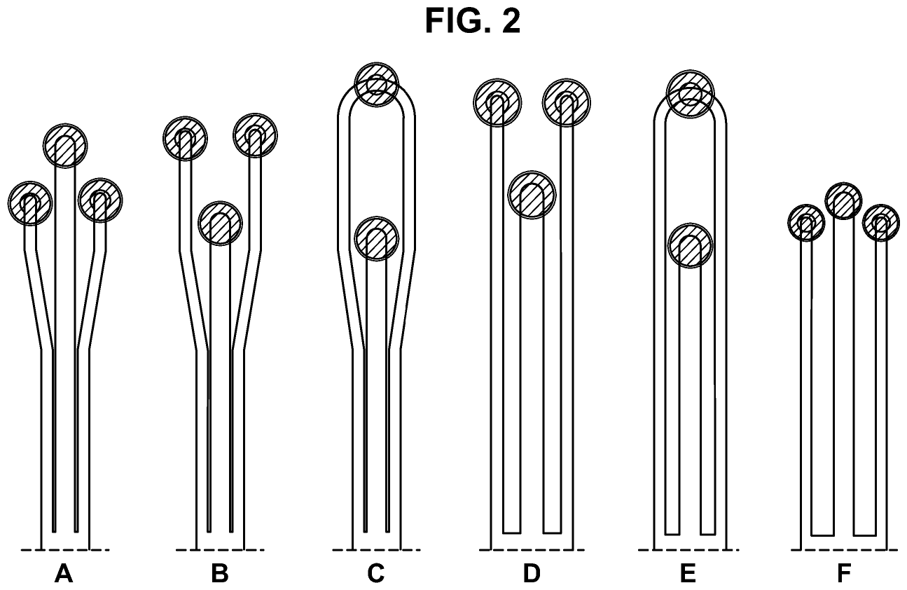

FIG. 1 provides a plan view of the general features of microfluidic devices (101) of the present invention. The device comprises a mixing chamber (102) having a distal end (107) comprising an outlet region (105) and a proximal end (108) comprising an inlet region (106). The inlet region comprises three channels, two substantially parallel outer channels (103a, 103b) and a linear channel (104) located between the two substantially parallel outer channels. The outer channels (103a, 103b) are configured for transport of a first fluid. The linear inner channel (104) is configured for transport of a second fluid. The mixing chamber (102) is configured to receive the first and second fluids from the inner and outer channels. Generally, the parallel channel outer walls (109a, 109b) and mixing chamber outer walls (109c, 109d) are continuous forming first (109a+09c) and second walls (109b+109d) that extend substantially the whole length of the device (101) between the proximal end (106) and distal end (107). Preferably, the first and second walls are linear and parallel with each other along substantially the whole length of the microfluidic chip.

The first fluid and second fluid are mixed within the mixing chamber. Fluid flows through the device in a direction (F) generally perpendicular to the width (W) of the mixing chamber. As the fluids travel along the length (L) of the mixing chamber, they mix to form lipid containing nanoparticles. The lipid containing nanoparticles and fluids exit the device through an opening (105) at the distal end of the device (107) and are collected. In preferred embodiments, the microfluidic device has a uniform width along substantially its whole length. This not only facilitates manufacture of the device but also enables multiple devices to be easily utilised in parallel.

The microfluidic device may be formed from at least one suitable substrate or material. A suitable substrate is one that is amenable to manufacture and which is inert or compatible with the components used in the first and second solutions. In preferred embodiments, the microfluidic device is fabricated using a substrate such as glass and/or silicon. Metal or plastics may also be used. Different substrate materials may have different advantages and disadvantages dictating the choice for a given application. Microfluidic devices are generally formed by making recessed channels in the or a first substrate. The substrate will generally be rectangular or square in shape having a substantially planar structure (i.e. having substantially flat upper and lower surfaces). However, it will be readily appreciated that a variety of shapes having a planar structure may be used. A second substrate may also be used, for example, to cover the recessed channels thereby defining a channel structure. Preferably microfluidic devices of the present invention are fabricated from silicon, for example an SiO₂ based material, and glass, for example, boro-silicate glass. Microfluidic devices of the present invention may be fabricated by making recessed channels in a first substrate, particularly a silicon substrate. A second substrate, particularly a glass substrate may be used to cover the recessed channels. The second substrate may comprise at least one fluid inlet (for example one or two) and/or at least one fluid outlet (for example, one or two). The at least one fluid inlet and/or at least one fluid outlet are in fluid communication with the recessed channels in the first substrate.

Channels and chambers may be formed in the substrate by a variety of means. For example, channels may be formed by etching, for example, chemical etching, Deep Reactive Ion Etching (DRIE or plasma etching) or wet etching (HF etching). A preferred method of fabricating microfluidic devices using a silicon substrate is DRIE. In some embodiments, the substrate may be mechanically abraded by selectively powder blasting the substrate surface. A preferred method of fabricating fluid inlets and outlets in a glass substrate is powder blasting. The mixing chamber, outer channels and inner channel may be formed by techniques known in the art such as powder blasting or deep reactive-ion etching (DRIE). The at least one fluid inlet and/or at least one fluid outlet may be formed by techniques known in the art such as powder blasting or deep reactive-ion etching (DRIE). In some embodiments the mixing chamber, outer channels and inner channel are formed by deep reactive-ion etching (DRIE) and at least one fluid inlet and/or at least one fluid outlet is formed by powder blasting.

The cross-section of the channels and the mixing chamber may be of any shape, although typically they will have a symmetrical cross-section. The cross-section may be substantially rectangular (such as square). Preferably microfluidic devices of the present invention comprise channels and a mixing chamber having a substantially rectangular cross-section. Particularly, the channels and mixing chamber are neither circular nor ‘U’ shaped in cross-section.

The mixing chamber may have a uniform width from the proximal end to the distal end. Particularly, by reference to FIG. 1, the width (W) of the mixing chamber (perpendicular to the inlet channels 103a, 103b and 104) is equal to or less than the total width of the inlet channels and the walls between the channels taken together (W₁). More particularly, the width (W) of the mixing chamber is equal to the distance between the outer walls of the inlet channels (W₁) and the mixing chamber has a uniform width along its length, i.e., from the distal end to the proximal end. In some embodiments, the width (W) of the mixing chamber is less than the distance between the outer walls of the inlet channels. A rectangular cross-section may have a long side (e.g. width) of 1 to 8.0 mm, such as 1 to 4.0 mm, for example 1.4 to 3.2 mm, especially 1.6 to 2.4 mm, in particular 1.8 to 2.2 mm (e.g. 2.0 mm). Alternatively, a rectangular cross-section may have a long side, for example a width, of 0.5 to 8.0 mm, such as 0.5 to 4.0 mm, for example 1.0 to 3.0 mm, especially 1.0 to 2.5 mm, in particular 1.0 to 2.0 mm (e.g. 1.0, 1.6, 1.8 or 2.0 mm). In certain embodiments a rectangular cross-section may have a long side of about 1800 μm (such as 1800 μm±100 μm or 1800 μm), about 1600 μm (such as 1600 μm±100 μm or 1600 μm), about 1500 μm (such as 1500 μm±100 μm or 1500 μm), about 1400 μm (such as 1400 μm±100 μm or 1400 μm), about 1300 μm (such as 1300 μm±100 μm or 1300 μm), about 1200 μm (such as 1200 μm±100 μm or 1200 μm), about 1100 μm (such as 1100 μm±100 μm or 1100 μm) or about 1000 μm (such as 1000 μm±100 μm or 1000 μm). In some embodiments, the mixing chamber is of consistent cross-section along its length.

A rectangular cross-section may have a short side (e.g. depth) of 0.1 to 4 mm, for example, 0.1 to 2 mm, optionally 0.1-1.2 mm, such as 0.1-0.8 mm, especially 0.2-0.6 mm, in particular 0.3-0.5 mm (e.g. 0.4 mm or 0.5 mm). Alternatively, a rectangular cross-section may have a short side of 0.1 to 4 mm, for example 0.1 to 2 mm, optionally 0.1-1.2 mm, such as 0.1-0.8 mm, 0.2 to 0.6 mm, 0.3 to 0.6 mm, in particular 0.35 to 0.55 mm, such as 0.4 to 0.5 mm. The short side (for example, depth) may be about 0.4 mm, such as 0.4 mm±40 μm or 0.4 mm. Alternatively the short side may be 0.44 mm to 0.56 mm, such as about 0.5 mm, such as 0.5 mm±40 μm, especially 0.5 mm. The mixing chamber may have a depth of from about 360 μm to about 540 μm, for example, about 410 μm, 420 μm, 430 μm, 440 μm, 450 μm, 460 μm, 470 μm, 480 μm, 490 μm or about 500 μm.

The mixing chamber will typically have a cross-sectional area which is 25.6 mm² or less, such as 12.8 mm² or less, suitably 6.4 mm² or less, especially 3.2 mm² or less and in particular 1.6 mm² or less, in particular 1 mm² or less. The mixing chamber will typically have a cross-sectional area which is 0.1 mm² or more, suitably 0.2 mm² or more, especially 0.3 mm² or more and in particular 0.4 mm² or more. In some embodiments the mixing chamber will have a cross-sectional area which is 0.2-3.2 mm², such as 0.4-1.5 mm², especially 0.4-1.0 mm². The cross-section may be elongate in nature, with the larger dimension being at least twice that of the perpendicular dimension, such as at least three times or at least four times or at least five times. The larger dimension may be no more than ten times that of the perpendicular dimension, such as no more than eight times or no more than six times. The larger dimension will usually be two to ten times that of the perpendicular dimension, such as three to eight times, especially four to six times, in particular five times.

Preferably, referring to FIG. 1, the outer wall (109a) of one of the two substantially parallel outer channels is continuous with the respective first outer wall (109c) of the mixing chamber and the outer wall (109b) of the other of the two substantially parallel outer channels is continuous with the respective second outer wall (109d) of the mixing chamber. More preferably, the outer walls of the two substantially parallel outer channels (109a and 109b) are continuous with the respective outer walls of the mixing chamber (109c and 109d) such that the outer walls of the microfluidic chip (defined by 109a+109c and 109b+109d) are linear and parallel with each other along substantially the whole length of the microfluidic chip, i.e. ‘W’ and ‘W₁’ are substantially the same, preferably the same.

In some embodiments, the mixing chamber tapers inwardly along at least a portion of its length from the proximal end to the distal end. In such embodiments, the proximal end of the mixing chamber may have a width of about 900 μm to about 2100 μm, about 1000 μm to about 2000 μm, such as about 2000 μm, about 1800 μm, about 1600 μm, about 1500 μm, about 1400 μm, about 1300 μm, about 1200 μm, about 1100 μm or about 1000 μm, for example, 2000 μm±100 μm, 1800 μm±100 μm, 1600 μm±100 μm, 1500 μm±100 μm, 1400 μm±100 μm, 1300 μm±100 μm, 1200 μm±100 μm, 1100 μm±100 μm or 1000 μm±100 μm, such as 2000 μm, 1800 μm, 1600 μm, 1500 μm, 1400 μm, 1300 μm, 1200 μm, 1100 μm or 1000 μm. The distal end of the mixing chamber may have a width of from about 400 μm to about 600 μm, for example, about 400 μm, about 500 μm or about 600 μm, for example, 400 μm±100 μm, 500 μm±100 μm or 600 μm±100 μm, such as 400 μm, 500 μm or 600 μm.

The mixing chamber should be of adequate length to allow for mixing of the first and second fluids to be substantially complete by the time liquid reaches the distal end, i.e. the outlet(s). Particularly, the mixing chamber has a length of from about 10 mm to about 100 mm, for example about 10 mm to about 50 mm, about 25 mm to about 50 mm, such as about 10 mm, about 20 mm, about 25 mm about 30 mm, about 35 mm, about 40 mm, about 45 mm, about 50 mm or about 55 mm, for example, 10 mm, 20 mm, 25 mm 30 mm, 35 mm, 40 mm, 45 mm, 50 mm or 55 mm.

The mixing chamber has a proximal end comprising an inlet region configured to receive the first and second fluids from the inner and outer channels. Thus, the mixing chamber will have at least three inlets for delivery of the first and second fluids from the outer and inner channels. Preferably the direction of flow of the first and second fluids into the mixing chamber is substantially parallel (e.g. within 15 degrees, such as within 10 degrees, in particular within 5 degrees), such as parallel, to the general direction of flow through the mixing chamber.

The mixing chamber has a distal end comprising an outlet region. Particularly the outlet region is for the exit of fluids and will comprise at least one opening, such as a an orifice, particularly a hole, via which fluids and nanoparticles can exit the mixing chamber for recovery of the mixed material. In some embodiments, the device may have a plurality of outlets from the mixing chamber for recovery of the mixed material, such as two or three outlets, which are later combined. Suitably the device will have a single outlet from the mixing chamber for recovery of the mixed material. Particularly the outlet has a smaller width than that of the mixing chamber. The outlet may be formed separately and attached to the mixing chamber or alternatively the outlet can be formed as an integral part of the microfluidic device. In some embodiments, the outlet is in the form of a hole on one of the flat surfaces of the microfluidic device, for example, a hole formed in a wall of the mixing chamber. Particularly, the outlet is a hole formed in the surface of the second substrate. The walls of the outlet may be tapered. The cross-section of the outlets may be of any shape, though is typically symmetrical. The cross-section may be rectangular (such as square) but is preferably conical. The outlet may be circular having a diameter of from about 650 μm to about 1500 μm, for example, about 650 μm, about 700 μm, about 750 μm, about 800 μm, about 850 μm, about 900 μm, about 950 μm, about 1000 μm, about 1100 μm, about 1150 μm, about 1200 μm, about 1250 μm, about 1300 μm, about 1350 μm, about 1400 μm, about 1450 μm, about 1500 μm, such as, 650 μm, 700 μm, 750 μm, 800 μm, 850 μm, 900 μm, 950 μm, 1000 μm, 1100 μm, 1150 μm, 1200 μm, 1250 μm, 1300 μm, 1350 μm, 1400 μm, 1450 μm, 1500 μm. The outlet may be conical having different top and bottom diameters of these values, for example, a top diameter of about 1500 μm and a bottom diameter of about 650 μm. The outlet may be cylindrical having top and bottom diameters that are substantially similar in size, for example, substantially equal in size, such as the same size. Thus, in some embodiments, the outlet is a cylindrical hole. In other embodiments, the outlet is a conical hole. In embodiments where the outlet is a conical hole, preferably the size of the lower or bottom diameter (closest to the mixing chamber) is smaller than the size of the upper or top diameter.

The two substantially parallel outer channels may each have a width of from about 400 μm or less, particularly about 200 μm or less, more particularly about 150 μm or less, yet more particularly about 100 μm, for example, 400 μm, 300 μm, 200 μm, 150 μm or 100 μm. In some embodiments the width of the two substantially parallel outer channels is 220 um to 500 um, such as 300-500 um, in particular about 300 um (e.g. 300 um), about 400 um (e.g. 400 um) or about 500 um (e.g. 500 um).

The two substantially parallel outer channels may each have a width of from about 400 μm or less, particularly about 200 μm or less, more particularly about 150 μm or less, yet more particularly about 100 μm, for example, 400 μm±40 μm, 200 μm±20 μm, 150 μm±15 μm or 100 μm±10 μm, such as 400 μm, 200 μm, 150 μm or 100 μm. In some embodiments the width of the two substantially parallel outer channels is 80 um to 180 um, such as 100-160 um, in particular about 100 um (e.g. 100 um) or about 150 um (e.g. 150 um).

The two substantially parallel outer channels may each have a width of more than 400 μm, for example, about 450 μm, about 500 μm, about 550 μm, about 600 μm, about 650 μm or about 700 μm, such as 450 μm±45 μm, about 500 μm±50 μm, 550 μm±55 μm, about 600 μm±60 μm, about 650 μm±65 μm or about 700 μm±70 μm, for example, 450 μm, 500 μm, 550 μm, 600 μm, 650 μm or 700 μm. In some embodiments the width of the two substantially parallel outer channels is about 200 um (e.g. 200 um)

The term “substantially parallel” is intended to mean that the two outer channels are generally straight, i.e. linear, channels parallel with each other however, there may also be configurations wherein a portion of each of the outer channels are angled and not perfectly parallel with each other. The two substantially parallel outer channels comprise first and second ends, the first ends being in fluid communication with a source of a first fluid, and the second ends in fluid communication with the mixing chamber. Preferably the direction of flow of the first fluid into the mixing chamber is substantially parallel (e.g. within 15 degrees, such as within 10 degrees, in particular within 5 degrees), such as parallel, to the general direction of flow through the mixing chamber. In preferred embodiments, the two substantially parallel outer channels may share a common inlet, in other words, the first ends of each of the two outer channels are in fluid communication. The first ends of each of the two outer channels may be continuous with one another, in the form of a ‘U’ or a ‘V’ having a common inlet, by way of non-limiting examples of this configuration, see for example FIGS. 2C and 2E. As used herein, the term “continuous” refers to a channel that extends continuously along a path without break or interruption. However, it will be apparent to one skilled in the art that the two substantially parallel outer channels may each have a separate inlet in fluid communication with a source of the first fluid.

The linear inner channel may have a width of about 400 μm or less, particularly about 270 μm or less, more particularly about 230 μm or less, yet more particularly about 200 μm or less, for example, about 400 μm, about 270 μm, about 250 μm about 230 μm, about 225 μm, about 220 μm, about 210 μm, about 200 μm, about 150 μm or about 100 μm, such as 400 μm±40 μm, 270 μm±27 μm, about 250 μm±25 μm about 230 μm±23 μm, about 225 μm±22 μm, about 220 μm±22 μm, about 210 μm±21 μm, about 200 μm±20 μm, about 150 μm±15 μm or about 100 μm±10 μm, particularly 400 μm, 270 μm, 250 μm 230 μm, 225 μm, 220 μm, 210 μm, 200 μm, 150 μm or 100 μm. The linear inner channel may have a width of from about 200 μm to about 400 μm, for example, about 400 μm, about 270 μm or about 230 μm. The linear inner channel may have a width of a width of from about 200 μm to about 700 μm, for example, greater than 400 μm, greater than 450 μm, greater than 500 μm, greater than 550 μm, greater than 600 μm, greater than 650 μm, for example, about 450 μm, about 500 μm, about 550 μm, about 600 μm, about 650 μm or about 700 μm, such as 450 μm±45 μm, 500 μm±50 μm, 550 μm±55 μm, 600 μm±60 μm, 650 μm±65 μm or 700 μm±70 μm, particularly 450 μm, 500 μm, 550 μm, 600 μm, 650 μm or 700 μm.

In some embodiments the width of the inner channel is 220 um to 500 um, such as 300-500 um, in particular about 300 um (e.g. 300 um), about 400 um (e.g. 400 um) or about 500 um (e.g. 500 um).

In some embodiments the width of the inner channel is 80 um to 180 um, such as 100-160 um, in particular about 100 um (e.g. 100 um) or about 150 um (e.g. 150 um).

In some embodiments the width of the inner channel is about 200 um (e.g. 200 um).

The term ‘linear’ in relation to the inner channel is intended to be construed to mean that the inner channel is straight along its length, i.e., without curves or angles. Particularly the linear fluid channel has a first end and a second end, the first end being in fluid communication with a source of a second fluid, for example via an inlet, and the second end in fluid communication with the mixing chamber. Preferably the direction of flow of the second fluid into the mixing chamber is substantially parallel (e.g. within 15 degrees, such as within 10 degrees, in particular within 5 degrees), such as parallel, to the general direction of flow through the mixing chamber. In preferred embodiments, the inner channel is disposed or positioned between the two substantially parallel outer channels. Particularly, the inner channel is disposed or positioned equidistant between the two substantially parallel outer channels. In certain embodiments, the inner channel is parallel with the two outer channels.

An inlet is for the entry of a fluid into the microfluidic device and will comprise an opening, such as a hole or orifice, through which a fluid may enter or be introduced into the device. Particularly an inlet may have a width or diameter approximately equal to or larger than the width of the respective channel. Inlets may be formed separately and attached to the channel or alternatively an inlet can be formed as an integral part of the microfluidic device. In some embodiments, an inlet is in the form of a hole on one of the flat surfaces of the microfluidic device, for example, a hole formed in a wall of the channel(s). The side of the hole may be straight or tapered.

The cross-section of the outer channels and internal channel is preferably rectangular (such as square).

For example, a rectangular cross-section may have a long side of 0.1 to 3.0 mm, such as 0.1 to 3.0 mm, for example 0.1 to 2.0 mm, especially 0.1 to 0.8 mm, in particular 0.1 to 0.7 mm (e.g. 0.1 mm, 0.15 mm, 0.2 mm, 0.23 mm, 0.25 mm, 0.27 mm, 0.3 mm, 0.35 mm, 0.4 mm or 0.7 mm). Alternatively, a rectangular cross-section may have a long side (for example a width) of about 700 μm (such as 700 μm±70 μm or 700 μm), about 600 μm (such as 600 μm±60 μm or 600 μm), about 500 μm (such as 500 μm±50 μm or 500 μm), about 400 μm (such as 400 μm±40 μm or 400 μm), about 300 μm (such as 300 μm±30 μm or 300 μm), about 270 μm (such as 270 μm±27 μm or 270 μm), about 250 μm (such as 250 μm±25 μm or 250 μm), about 230 μm (such as 230 μm±23 μm or 230 μm), 200 μm (such as 200 μm±20 μm or 200 μm), 150 μm (such as 150 μm±15 μm or 150 μm) or about 100 μm (such as 100 μm±10 μm or 100 μm). A rectangular cross-section may have a short side of 0.1 to 4 mm, for example 0.1 to 2 mm, optionally 0.1-1.2 mm, such as 0.1-0.8 mm, 0.2 to 0.6 mm, 0.3 to 0.6 mm, in particular 0.4-0.5 mm. The short side (for example, depth) may be about 0.4 mm, such as 0.4 mm±40 μm or 0.4 mm. Alternatively the short side may be 0.44 mm to 0.56 mm, such as about 0.5 mm, such as 0.5 mm±40 μm, especially 0.5 mm. The mixing chamber may have a depth of from about 360 μm to about 540 μm, for example, 410 μm, 410 μm, 420 μm, 430 μm, 440 μm, 450 μm, 460 μm, 470 μm, 480 μm, 490 μm or about 500 μm.

The outer channels and internal channel will typically have a cross-sectional area which is 1.28 mm² or less, suitably 0.5 mm² or less, especially 0.35 mm² or less. Each channel will typically have a cross-sectional area which is 0.01 mm² or more, suitably 0.02 mm² or more, especially 0.03 mm² or more and in particular 0.04 mm² or more. In some embodiments each channel will have a cross-sectional area which is 0.04-0.35 mm², such as 0.08-0.35 mm², 0.04-0.2 mm², for example 0.08 mm², 0.35 mm², 0.04 mm² or 0.2 mm². The total cross-sectional area of the outer and internal channels will suitably be less than 70% of the cross-sectional area of the mixing chamber, such as less than 60% and especially less than 50%.

The shape and size of each channel and the mixing chamber may be varied independently. Typically the two outer channels will have an identical shape and size. In some embodiments, the outer and internal channels are identical in shape and size. In other embodiments, the outer channels and internal channels are identical in shape but different in size. In other embodiments, the outer channels and internal channel are different in both shape and size. In preferred embodiments, the two substantially parallel outer channels are of consistent cross-section along their length. In preferred embodiments, the linear channel is of consistent cross-section along its length. In preferred embodiments of the invention, the microfluidic device is symmetrical about its longitudinal axis.

As discussed above, the microfluidic device will be formed from, or comprise, at least one substrate, for example, two substrates. Particularly the substrate is a silicon and/or glass. More particularly, the substrate is a silicon layer and/or a glass layer. In some embodiments, the substrate comprises a silicon layer and a glass layer. Layers may be connected or joined together by a variety of means, for example by fusion under pressure with heat, by ultrasonic welding or at high temperature inside an electric field. Preferably the microfluidic device comprises a silicon layer fixed to a glass layer using an anodic bond. The number of layers in the device may depend on the fabrication process chosen. Particularly the mixing chamber, outer channels and inner channel are formed in a silicon layer. In some embodiments, the mixing chamber, outer channels and inner channel, at least one fluid inlet and/or at least one fluid outlet are formed in the silicon layer. In some embodiments a glass layer is disposed onto the silicon layer. The glass layer may form a lid or seal closing the top of the channel formed in the silicon layer. In some embodiments the mixing chamber, outer channels and inner channel are formed in the silicon layer and at least one fluid inlet and/or at least one fluid outlet is formed in the glass layer. Preferably the silicon layer is fixed to the glass layer in a positional relationship such that the glass layer cooperatively defines one side of the channels and mixing chamber. Particularly the glass layer comprises at least one inlet, for example, two inlets that is in positional alignment with the first end of at least one channel. Particularly the glass layer comprises at least one outlet, that is in positional alignment with the distal end of the mixing chamber.

The microfluidic device may be connected to a reservoir comprising the first and/or second fluids. Preferably one of the first and second fluid is an aqueous fluid. Preferably one of the first and second fluids is a non-aqueous fluid or a fluid comprising a lipid, such as a cationic lipid. The microfluidic device may be connected to at least one pump. The microfluidic device may be connected to at least one collection chamber.

Microfluidic devices of the invention may be provided in the form of a “chip”. The term “chip” refers to a freestanding microfluidic layer that may subsequently be integrated into a holder containing inlet and outlet connections. Each chip may contain one microfluidic device or a multitude of microfluidic devices. For example, a plurality of microfluidic devices, for example, 2 or more, in particular 4 or more, especially 8 or more, such as 16 or more, 32 or more, 64 or more or 128 or more. The plurality of microfluidic devices may be 128 or fewer, such as 64 or fewer, in particular 32 or fewer. Consequently, in some embodiments the plurality of microfluidic devices is 2-128, such as 4-64, for example 8-32. The edges of the chip may include raised ridges to provide an adequate gripping surface or to allow registration or orientation of the device. Microfluidic devices of the present invention may be operated in parallel. A number of chips can be used in parallel to provide the plurality of microfluidic devices (e.g. two chips each of which contains 8 microfluidic devices to provide a total of 16 microfluidic devices to be operated in parallel).

In some circumstances each microfluidic device may be operated independently, with provision of the first fluid and second fluid to the mixing chamber by independent pumps (i.e. each pump not concurrently providing solution to any other mixing chamber). The first fluid and/or second fluid may be stored in independent containers (i.e. containers not concurrently providing first fluid and/or second fluid to more than one microfluidic device), or first fluid and/or second fluid may be stored in a container for use in more than one microfluidic device (such as all microfluidic devices). Mixed material from each microfluidic device may be recovered individually and stored/processed, optionally being combined at a later stage, or may be combined (e.g. from all microfluidic devices) before further processing and/or storage.

Conveniently all microfluidic devices in the plurality of microfluidic devices are supplied by the same pumps and mixed material from all mixing chambers is collected before further processing and/or storage. Particularly the total flow rate (TFR) in the microfluidic device, is greater than 8 ml/min/mm² for example, between 8-30 mL/min/mm², 12-28 mL/min/mm², 14-26 mL/min/mm², 16-24 mL/min/mm², or about 14 mL/min/mm², or about 15 mL/min/mm², or about 16 mL/min/mm², or about 18 mL/min/mm² or about 22 mL/min/mm².

Optimally the microfluidic devices, inlets and outlets, supply of first fluid, second fluid and collection of mixed material of multiple mixing chambers are configured such that in operation they perform substantially identically.

Suitably the plurality of mixing chambers is capable of producing mixed material at a total rate of 50-2000 ml/min, such as 100-1000 ml/min, in particular 200-500 ml/min. In some embodiments, the plurality of mixing chambers is capable of producing mixed material at a rate of at least 1 g of cationic lipid per minute. In some embodiments. all mixing chambers in the plurality of mixing chambers are supplied by the same pumps and mixed material from all mixing chambers is collected before further processing and/or storage.

FIG. 2 provides the architecture of six embodiments of the inlet region of microfluidic devices of the invention. The inlet region comprising two substantially parallel outer channels configured for transport of a first fluid and a linear inner channel configured for transport of a second fluid. The linear channel is disposed between the two substantially parallel outer channels. Embodiments 2A, 2B, 2D and 2F each comprise three separate inlets. In contrast Embodiments 2C and 2E comprise two separate inlets wherein the two substantially parallel channels are continuous.

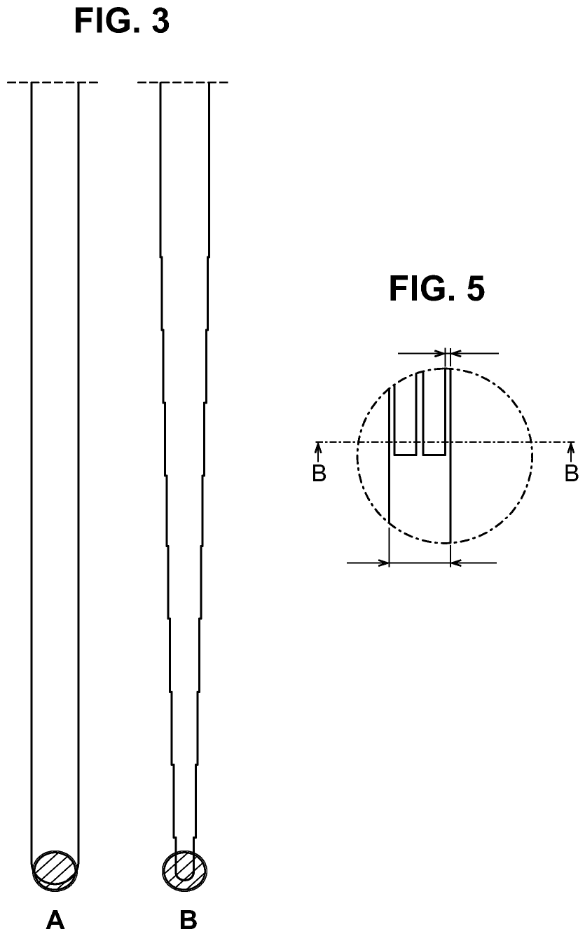

FIG. 3 provides the architecture of two embodiments of the mixing chamber of microfluidic devices of the invention. The mixing chamber of Embodiment 3A is linear along its length. In contrast, the walls of the mixing chamber of Embodiment 3B taper inwardly along a portion of its length from the distal end to the proximal end.

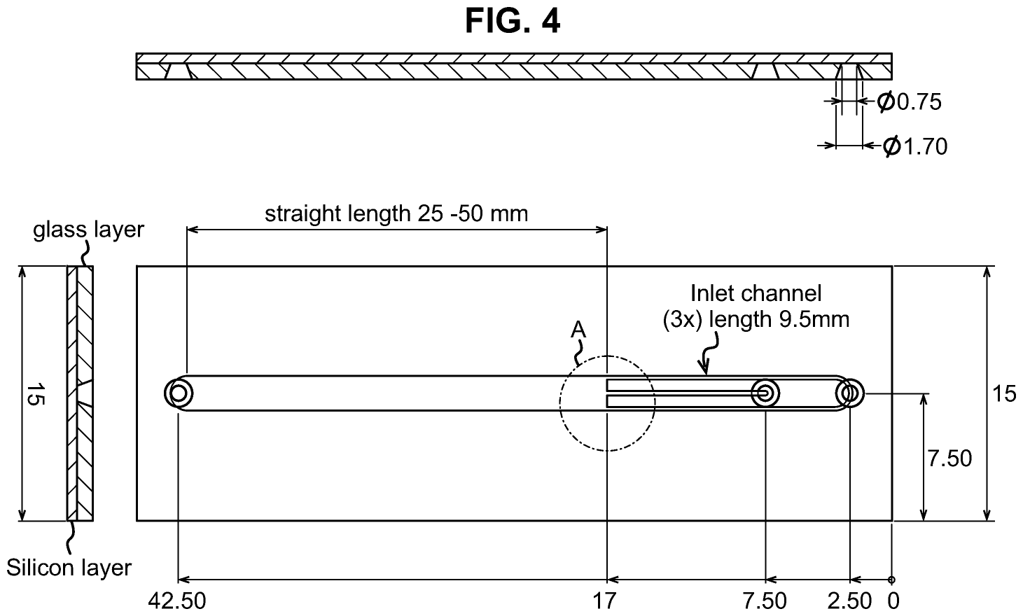

FIG. 4 provides the architecture of a microfluidic device of the invention comprising a silicon substrate comprising a mixing chamber having a distal end comprising an outlet region and a proximal end comprising an inlet region, the inlet region comprising two substantially parallel outer channels configured for transport of a first fluid and a linear inner channel configured for transport of a second fluid, the two substantially parallel outer channels comprise first and second ends, the first ends being in fluid communication with a source of a first fluid via a first inlet hole, and the second ends in fluid communication with the mixing chamber, wherein the linear channel is disposed between the two substantially parallel outer channels and has a first end and a second end, the first end being in fluid communication with a source of a second fluid via a second inlet hole, and the second end in fluid communication with the mixing chamber, wherein the mixing chamber is configured to receive the first and second fluids from the inner and outer channels; and a glass substrate comprising the first and second inlet holes and an outlet hole, wherein the first and second inlet holes are in positional alignment with the first ends of the two substantially parallel outer channels and the linear inner channel respectively and wherein the outlet hole is in positional alignment with the outlet region of the mixing chamber; wherein the silicon substrate is anodically bonded to the glass substrate thereby cooperatively defining the channels and mixing chamber. The silicon layer is fabricated using anisotropic deep reactive ion etching (DRIE) to form channels in the silicon substrate. The glass layer is fabricated by powder blasting inlet and outlet holes. In order to complete fabrication of the device, the silicon layer is anodically bonded to the glass layer. The device is connected to inlet and outlet ports that will allow fluids to travel from a source into the device. Flow is controlled by pressure-driven flow provided by a syringe pump. FIG. 5 provides a magnified view of part A from FIG. 4.

### Embodiments of the Invention

The invention is further illustrated by the following embodiments

EMBODIMENT 1: A microfluidic device comprising a mixing chamber having a distal end comprising an outlet region and a proximal end comprising an inlet region, the inlet region comprising two substantially parallel outer channels configured for transport of a first fluid and an inner channel configured for transport of a second fluid, wherein the inner channel is disposed between the two substantially parallel outer channels, and wherein the mixing chamber is configured to receive the first and second fluids from the inner and outer channels, and wherein:

the inner channel is linear;

the channels and mixing chamber have a depth of greater than 400 um;

the width of the two substantially parallel outer channels is greater than 200 um;

the width of the two substantially parallel outer channels is less than 200 um;

the width of the inner channel is greater than 200 um;

the width of the inner channel is less than 200 um;

the mixing chamber has a length of greater than 25 mm;

the mixing chamber has a width of less than 2000 um; and/or the mixing chamber is tapered along its length.

EMBODIMENT 2: The microfluidic device according to Embodiment 1, wherein the inner channel is linear.

EMBODIMENT 3: The microfluidic device according to either Embodiment 1 or 2, the channels and mixing chamber have a depth of greater than 400 um.

EMBODIMENT 4: The microfluidic device according to Embodiment 3, wherein the mixing chamber has a uniform depth from the proximal end to the distal end.

EMBODIMENT 5: The microfluidic device according to any one of Embodiments 1 to 4, wherein the mixing chamber has rectangular cross-section with a depth of 0.1 to 4 mm, for example, 0.1 to 2 mm, optionally 0.1-1.2 mm, such as 0.1-0.8 mm, especially 0.2-0.6 mm, in particular 0.3-0.5 mm (e.g. 0.4 mm).

EMBODIMENT 6: The microfluidic device according to any one of Embodiments 1 to 4, wherein the mixing chamber has rectangular cross-section with a depth of 0.1 to 4 mm, for example 0.1 to 2 mm, optionally 0.1-1.2 mm, such as 0.1-0.8 mm, 0.2 to 0.6 mm, 0.3 to 0.6 mm, in particular 0.35 to 0.55 mm, such as 0.4 to 0.5 mm.

EMBODIMENT 7: The microfluidic device according to any one of Embodiments 1 to 4, wherein the mixing chamber has rectangular cross-section with a depth of 0.44 mm to 0.56 mm, such as about 0.5 mm, such as 0.5 mm±40 μm, especially 0.5 mm.

EMBODIMENT 8: The microfluidic device according to any one of Embodiments 1 to 7, wherein the width of the two substantially parallel outer channels is greater than 200 um.

EMBODIMENT 9: The microfluidic device according to Embodiment 8, wherein the width of the two substantially parallel outer channels is 220 um to 500 um, such as 300-500 um, in particular about 300 um (e.g. 300 um), about 400 um (e.g. 400 um) or about 500 um (e.g. 500 um).

EMBODIMENT 10: The microfluidic device according to any one of Embodiments 1 to 7, wherein the width of the two substantially parallel outer channels is less than 200 um.

EMBODIMENT 11: The microfluidic device according to Embodiment 10, wherein the width of the two substantially parallel outer channels is 80 um to 180 um, such as 100-160 um, in particular about 100 um (e.g. 100 um) or about 150 um (e.g. 150 um).

EMBODIMENT 12: The microfluidic device according to any one of Embodiments 1 to 7, wherein the width of the two substantially parallel outer channels is about 200 um (e.g. 200 um).

EMBODIMENT 13: The microfluidic device according to any one of Embodiments 1 to 12, wherein the inner channel is greater than 200 um.

EMBODIMENT 14: The microfluidic device according to Embodiment 13, wherein the width of the inner channel is 220 um to 500 um, such as 300-500 um, in particular about 300 um (e.g. 300 um), about 400 um (e.g. 400 um) or about 500 um (e.g. 500 um).

EMBODIMENT 15: The microfluidic device according to any one of Embodiments 1 to 12, wherein the width of the inner channel is less than 200 um.

EMBODIMENT 16: The microfluidic device according to Embodiment 15, wherein the width of the inner channel is 80 um to 180 um, such as 100-160 um, in particular about 100 um (e.g. 100 um) or about 150 um (e.g. 150 um).

EMBODIMENT 17: The microfluidic device according to any one of Embodiments 1 to 12, wherein the width of the inner channel is about 200 um (e.g. 200 um).

EMBODIMENT 18: The microfluidic device according to any one of Embodiments 1 to 17, wherein the mixing chamber has a length of greater than 25 mm.

EMBODIMENT 19: The microfluidic device according to Embodiment 18, wherein the mixing chamber has a length of 3-10 cm, such as 3-8 cm, especially 3.5-6.5 cm, in particular 3-6 cm, for example about 5 cm (e.g. 5 cm).

EMBODIMENT 20: The microfluidic device according to any one of Embodiments 1 to 17, wherein the mixing chamber has a length of 1-10 cm, such as 1.5-5 cm, especially 1.8-4 cm, in particular 2-3 cm, for example about 2.5 cm (e.g. 2.5 cm).

EMBODIMENT 21: The microfluidic device according to any one of Embodiments 1 to 20, wherein the mixing chamber has a width of less than 2000 um.

EMBODIMENT 22: The microfluidic device according to Embodiment 21, wherein the mixing chamber has rectangular cross-section with a long side about 1800 μm (such as 1800 μm±100 μm or 1800 μm), about 1600 μm (such as 1600 μm±100 μm or 1600 μm), about 1500 μm (such as 1500 μm±100 μm or 1500 μm), about 1400 μm (such as 1400 μm±100 μm or 1400 μm), about 1300 μm (such as 1300 μm±100 μm or 1300 μm), about 1200 μm (such as 1200 μm±100 μm or 1200 μm), about 1100 μm (such as 1100 μm±100 μm or 1100 μm) or about 1000 μm (such as 1000 μm±100 μm or 1000 μm).

EMBODIMENT 23: The microfluidic device according to any one of Embodiments 1 to 20, wherein the mixing chamber has a width of 1 to 8.0 mm, such as 1 to 4.0 mm, for example 1.4 to 3.2 mm, especially 1.6 to 2.4 mm, in particular 1.8 to 2.2 mm (e.g. 2.0 mm).

EMBODIMENT 24: The microfluidic device according to any one of Embodiments 1 to 23, wherein the mixing chamber has a uniform width from the proximal end to the distal end.

EMBODIMENT 25: The microfluidic device according to any one of Embodiments 1 to 24, wherein the mixing chamber has a uniform depth from the proximal end to the distal end.

EMBODIMENT 26: The microfluidic device according to any one of Embodiments 1 to 26, wherein the mixing chamber is tapered along its length.

EMBODIMENT 27: The microfluidic device according to Embodiment 26, wherein the width of mixing chamber is tapered along its length.

EMBODIMENT 28: The microfluidic device according to either one of Embodiment 26 or 27, wherein the depth of mixing chamber is tapered along its length.

EMBODIMENT 29: A microfluidic device comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, and wherein the mixing chamber is configured to receive the first and second fluids from the inner and outer channels.

EMBODIMENT 30: A microfluidic device according to Embodiment 29 comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the channels and mixing chamber have a depth of about 500 μm or about 400 μm.

EMBODIMENT 30A: A microfluidic device according to Embodiment 30 wherein the channels and mixing chamber have a depth of about 400 μm.

EMBODIMENT 30B: A microfluidic device according to Embodiment 30 wherein the channels and mixing chamber have a depth of about 500 μm.

EMBODIMENT 31: A microfluidic device according to any preceding Embodiment comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the width of the two substantially parallel outer channels is about 400 μm or less.

EMBODIMENT 31A: A microfluidic device according to any preceding Embodiment wherein the width of the two substantially parallel outer channels is about 200 μm or less.

EMBODIMENT 31B: A microfluidic device according to any preceding Embodiment wherein the width of the two substantially parallel outer channels is about 150 μm or less.

EMBODIMENT 31C: A microfluidic device according to any preceding Embodiment wherein the width of the two substantially parallel outer channels is about 100 μm.

EMBODIMENT 31D: A microfluidic device according to any preceding Embodiment wherein the width of the two substantially parallel outer channels is from about 100 μm to about 400 μm.

EMBODIMENT 31E: A microfluidic device according to any preceding Embodiment wherein the width of the two substantially parallel outer channels is about 200 μm.

EMBODIMENT 31F: A microfluidic device according to any preceding Embodiment wherein the width of the two substantially parallel outer channels is about 150 μm.

EMBODIMENT 32: A microfluidic device according to any preceding Embodiment comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the width of the linear inner channel is about 400 μm or less

EMBODIMENT 32A: A microfluidic device according to any preceding Embodiment, wherein the width of the linear inner channel is about 270 μm or less.

EMBODIMENT 32B: A microfluidic device according to any preceding Embodiment, wherein the width of the linear inner channel is about 230 μm or less.

EMBODIMENT 32C: A microfluidic device according to any preceding Embodiment, wherein the width of the linear inner channel is about 200 μm.

EMBODIMENT 32D: A microfluidic device according to any preceding Embodiment, wherein the width of the linear inner channel is from about 200 μm to about 400 μm.

EMBODIMENT 32E: A microfluidic device according to any preceding Embodiment, wherein the width of the linear inner channel is about 400 μm.

EMBODIMENT 32F: A microfluidic device according to any preceding Embodiment, wherein the width of the linear inner channel is about 270 μm.

EMBODIMENT 32G: A microfluidic device according to any preceding Embodiment, wherein the width of the linear inner channel is about 230 μm.

EMBODIMENT 33: A microfluidic device according to any preceding Embodiment comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the width of the linear inner channel is greater than 400 μm.

EMBODIMENT 33A: A microfluidic device according to any preceding Embodiment wherein the width of the linear inner channel is greater than 630 μm.

EMBODIMENT 33B: A microfluidic device according to any preceding Embodiment wherein the width of the linear inner channel is greater than 700 μm.

EMBODIMENT 33C: A microfluidic device according to any preceding Embodiment wherein the width of the linear inner channel is greater than 770 μm.

EMBODIMENT 34: A microfluidic device according to any preceding Embodiment comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the mixing chamber has a length of from about 10 mm to about 100 mm.

EMBODIMENT 34A: A microfluidic device according to any preceding Embodiment wherein the mixing chamber has a length of from about 10 mm to about 55 mm.

EMBODIMENT 34B: A microfluidic device according to any preceding Embodiment wherein the mixing chamber has a length of from about 20 mm to about 55 mm.

EMBODIMENT 34C: A microfluidic device according to any preceding Embodiment wherein the mixing chamber has a length of from about 20 mm to about 50 mm.

EMBODIMENT 34D: A microfluidic device according to any preceding Embodiment wherein the mixing chamber has a length of from about 25 mm to about 50 mm.

EMBODIMENT 34E: A microfluidic device according to any preceding Embodiment wherein the mixing chamber has a length of 25 mm.

EMBODIMENT 34F: A microfluidic device according to any preceding Embodiment wherein the mixing chamber has a length of about 50 mm.

EMBODIMENT 35: A microfluidic device according to any preceding Embodiment comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the mixing chamber has a width of about 2000 μm or less

EMBODIMENT 35A: A microfluidic device according to any one preceding Embodiment, wherein the mixing chamber has a width of about 1800 μm or less.

EMBODIMENT 35B: A microfluidic device according to any one preceding Embodiment, wherein the mixing chamber has a width of about 1600 μm or less.

EMBODIMENT 35C: A microfluidic device according to any one preceding Embodiment, wherein the mixing chamber has a width of about 1000 μm.

EMBODIMENT 36: A microfluidic device according to any of Embodiments 1 to 6F comprising a mixing chamber having a distal end comprising an outlet region and a proximal end comprising an inlet region, the inlet region comprising two substantially parallel outer channels configured for transport of a first fluid and a linear inner channel configured for transport of a second fluid, wherein the linear channel is disposed between the two substantially parallel outer channels, wherein the mixing chamber is configured to receive the first and second fluids from the inner and outer channels, and wherein the mixing chamber tapers inwardly along at least a portion of its length from the distal end to the proximal end.

EMBODIMENT 36A: A microfluidic device according to Embodiment 8 wherein the mixing chamber tapers inwardly along at least a portion of its length from about 1600 μm to about 500 μm.

EMBODIMENT 37: A microfluidic device according to any preceding Embodiment wherein the two substantially parallel outer channels comprise first and second ends, the first ends being in fluid communication with a source of a first fluid, for example via an inlet, and the second ends in fluid communication with the mixing chamber.

EMBODIMENT 38: A microfluidic device according to any preceding Embodiment wherein the two substantially parallel outer channels share a common inlet.

EMBODIMENT 39: A microfluidic device according to any preceding Embodiment wherein each of the two outer channels are in fluid communication or wherein the two substantially parallel outer channels have separate inlets in fluid communication with a source of the first fluid.

EMBODIMENT 40: A microfluidic device according to any preceding Embodiment wherein the linear fluid channel has a first end and a second end, the first end being in fluid communication with a source of a second fluid, for example via an inlet, and the second end in fluid communication with the mixing chamber.

EMBODIMENT 41: A microfluidic device according to any preceding Embodiment wherein the linear fluid channel is aligned parallel to the general direction of flow through the mixing chamber.

EMBODIMENT 42: A microfluidic device according to any preceding Embodiment wherein the inner channel is disposed or positioned between the two substantially parallel outer channels.

EMBODIMENT 43: A microfluidic device according to any preceding Embodiment wherein the inner channel is disposed or positioned equidistant between the two substantially parallel outer channels.

EMBODIMENT 44: A microfluidic device according to any preceding Embodiment wherein the inner channel is parallel with the two outer channels.

EMBODIMENT 45: A chip comprising a microfluidic device according to any preceding Embodiment.

EMBODIMENT 46: A method of forming at least one nanoparticle using the microfluidic device or chip of any preceding Embodiment.

EMBODIMENT 47: A microfluidic device (101) comprising a substrate which extends between a distal end (107) comprising an outlet region (105) and a proximal end (108) comprising an inlet region (106), wherein the inlet region comprises two substantially parallel outer channels (103a, 103b) for transport of a first fluid, said outer channels (103a,103b) defined in part by a first outer wall (109a) and a second outer wall (109b) respectively, and a linear inner channel (104) for transport of a second fluid, wherein the linear channel is disposed between the two substantially parallel outer channels, wherein the outer channels (103a,103b) and inner channel (104) extend from the proximal end (108) to a mixing chamber (102) which extends from the inlet region (106) to the outlet region (105), wherein the mixing chamber (102) is in flow communication with the inner and outer channels (103a,103b,104) to receive the first and second fluids from the inner and outer channels (103a,103b,104), wherein the mixing chamber (102) has a uniform width (W) along its length substantially equal to the width (W1) between the outer walls (109a, 109b) of the two substantially parallel outer channels (103a,103b) and wherein the mixing chamber (102) is defined in part by a first outer wall (109c) and a second outer wall (109d) which are continuous with the respective outer walls (109a, 109b) of the two substantially parallel outer channels (103a, 103b).

EMBODIMENT 47A: The microfluidic device of EMBODIMENT 47 wherein the parallel channel outer walls (109a, 109b) and mixing chamber outer walls (109c, 109d) are provided by a first (109a,109c) and second wall (109b, 109d) which extend substantially the whole length of the device (101) between the proximal end (106) and distal end (107), and said first and second wall are linear and parallel with each other along substantially the whole length of the microfluidic chip.

EMBODIMENT 47B: The microfluidic device of EMBODIMENT 47 or 47A wherein the dimensions of the outer channel widths, linear internal channel width, mixing chamber width, depth and mixing chamber length are selected from the following specific combinations of:
i. Outer channel widths 0.4 mm; Linear internal channel width 0.2 mm; Mixing chamber width (W) 3 mm; Depth 400 um; Mixing chamber length 25 mm;
ii. Outer channel widths 0.4 mm; Linear internal channel width 0.2 mm; Mixing chamber width (W) 3 mm; Depth 400 um; Mixing chamber length 50 mm;
iii. Outer channel widths 0.4 mm; Linear internal channel width 0.2 mm; Mixing chamber width (W) 3 mm; Depth 500 um; Mixing chamber length 25 mm;
iv. Outer channel widths 0.4 mm; Linear internal channel width 0.2 mm; Mixing chamber width (W) 3 mm; Depth 500 um; Mixing chamber length 50 mm;
v. Outer channel widths 0.4 mm; Linear internal channel width 0.2 mm; Mixing chamber width (W) 2 mm; Depth 400 um; Mixing chamber length 25 mm;
vi. Outer channel widths 0.4 mm; Linear internal channel width 0.2 mm; Mixing chamber width (W) 2 mm; Depth 400 um; Mixing chamber length 50 mm;
vii. Outer channel widths 0.4 mm; Linear internal channel width 0.2 mm; Mixing chamber width (W) 2 mm; Depth 500 um; Mixing chamber length 25 mm;
viii. Outer channel widths 0.4 mm; Linear internal channel width 0.2 mm; Mixing chamber width (W) 2 mm; Depth 500 um; Mixing chamber length 50 mm;
ix. Outer channel widths 0.4 mm; Linear internal channel width 0.2 mm; Mixing chamber width (W) 1 mm; Depth 400 um; Mixing chamber length 25 mm;
x. Outer channel widths 0.4 mm; Linear internal channel width 0.2 mm; Mixing chamber width (W) 1 mm; Depth 400 um; Mixing chamber length 50 mm;
xi. Outer channel widths 0.4 mm; Linear internal channel width 0.2 mm; Mixing chamber width (W) 1 mm; Depth 500 um; Mixing chamber length 25 mm;
xii. Outer channel widths 0.4 mm; Linear internal channel width 0.2 mm; Mixing chamber width (W) 1 mm; Depth 500 um; Mixing chamber length 50 mm;
xiii. Outer channel widths 0.4 mm; Linear internal channel width 0.1 mm; Mixing chamber width (W) 3 mm; Depth 400 um; Mixing chamber length 25 mm;
xiv. Outer channel widths 0.4 mm; Linear internal channel width 0.1 mm; Mixing chamber width (W) 3 mm; Depth 400 um; Mixing chamber length 50 mm;
xv. Outer channel widths 0.4 mm; Linear internal channel width 0.1 mm; Mixing chamber width (W) 3 mm; Depth 500 um; Mixing chamber length 25 mm;
xvi. Outer channel widths 0.4 mm; Linear internal channel width 0.1 mm; Mixing chamber width (W) 3 mm; Depth 500 um; Mixing chamber length 50 mm;
xvii. Outer channel widths 0.4 mm; Linear internal channel width 0.1 mm; Mixing chamber width (W) 2 mm; Depth 400 um; Mixing chamber length 25 mm;
xviii. Outer channel widths 0.4 mm; Linear internal channel width 0.1 mm; Mixing chamber width (W) 2 mm; Depth 400 um; Mixing chamber length 50 mm;
xix. Outer channel widths 0.4 mm; Linear internal channel width 0.1 mm; Mixing chamber width (W) 2 mm; Depth 500 um; Mixing chamber length 25 mm;
xx. Outer channel widths 0.4 mm; Linear internal channel width 0.1 mm; Mixing chamber width (W) 2 mm; Depth 500 um; Mixing chamber length 50 mm;
xxi. Outer channel widths 0.4 mm; Linear internal channel width 0.1 mm; Mixing chamber width (W) 1 mm; Depth 400 um; Mixing chamber length 25 mm;
xxii. Outer channel widths 0.4 mm; Linear internal channel width 0.1 mm; Mixing chamber width (W) 1 mm; Depth 400 um; Mixing chamber length 50 mm;
xxiii. Outer channel widths 0.4 mm; Linear internal channel width 0.1 mm; Mixing chamber width (W) 1 mm; Depth 500 um; Mixing chamber length 25 mm;
xxiv. Outer channel widths 0.4 mm; Linear internal channel width 0.1 mm; Mixing chamber width (W) 1 mm; Depth 500 um; Mixing chamber length 50 mm;
xxv. Outer channel widths 0.3 mm; Linear internal channel width 0.2 mm; Mixing chamber width (W) 3 mm; Depth 400 um; Mixing chamber length 25 mm;
xxvi. Outer channel widths 0.3 mm; Linear internal channel width 0.2 mm; Mixing chamber width (W) 3 mm; Depth 400 um; Mixing chamber length 50 mm;
xxvii. Outer channel widths 0.3 mm; Linear internal channel width 0.2 mm; Mixing chamber width (W) 3 mm; Depth 500 um; Mixing chamber length 25 mm;
xxviii. Outer channel widths 0.3 mm; Linear internal channel width 0.2 mm; Mixing chamber width (W) 3 mm; Depth 500 um; Mixing chamber length 50 mm;
xxix. Outer channel widths 0.3 mm; Linear internal channel width 0.2 mm; Mixing chamber width (W) 2 mm; Depth 400 um; Mixing chamber length 25 mm;
xxx. Outer channel widths 0.3 mm; Linear internal channel width 0.2 mm; Mixing chamber width (W) 2 mm; Depth 400 um; Mixing chamber length 50 mm;
xxxi. Outer channel widths 0.3 mm; Linear internal channel width 0.2 mm; Mixing chamber width (W) 2 mm; Depth 500 um; Mixing chamber length 25 mm;
xxxii. Outer channel widths 0.3 mm; Linear internal channel width 0.2 mm; Mixing chamber width (W) 2 mm; Depth 500 um; Mixing chamber length 50 mm;
xxxiii. Outer channel widths 0.3 mm; Linear internal channel width 0.2 mm; Mixing chamber width (W) 1 mm; Depth 400 um; Mixing chamber length 25 mm;
xxxiv. Outer channel widths 0.3 mm; Linear internal channel width 0.2 mm; Mixing chamber width (W) 1 mm; Depth 400 um; Mixing chamber length 50 mm;
xxxv. Outer channel widths 0.3 mm; Linear internal channel width 0.2 mm; Mixing chamber width (W) 1 mm; Depth 500 um; Mixing chamber length 25 mm;
xxxvi. Outer channel widths 0.3 mm; Linear internal channel width 0.2 mm; Mixing chamber width (W) 1 mm; Depth 500 um; Mixing chamber length 50 mm;
xxxvii. Outer channel widths 0.3 mm; Linear internal channel width 0.1 mm; Mixing chamber width (W) 3 mm; Depth 400 um; Mixing chamber length 25 mm;
xxxviii. Outer channel widths 0.3 mm; Linear internal channel width 0.1 mm; Mixing chamber width (W) 3 mm; Depth 400 um; Mixing chamber length 50 mm;
xxxix. Outer channel widths 0.3 mm; Linear internal channel width 0.1 mm; Mixing chamber width (W) 3 mm; Depth 500 um; Mixing chamber length 25 mm;
xl. Outer channel widths 0.3 mm; Linear internal channel width 0.1 mm; Mixing chamber width (W) 3 mm; Depth 500 um; Mixing chamber length 50 mm;
xli. Outer channel widths 0.3 mm; Linear internal channel width 0.1 mm; Mixing chamber width (W) 2 mm; Depth 400 um; Mixing chamber length 25 mm;
xlii. Outer channel widths 0.3 mm; Linear internal channel width 0.1 mm; Mixing chamber width (W) 2 mm; Depth 400 um; Mixing chamber length 50 mm;
xliii. Outer channel widths 0.3 mm; Linear internal channel width 0.1 mm; Mixing chamber width (W) 2 mm; Depth 500 um; Mixing chamber length 25 mm;
xliv. Outer channel widths 0.3 mm; Linear internal channel width 0.1 mm; Mixing chamber width (W) 2 mm; Depth 500 um; Mixing chamber length 50 mm;
xlv. Outer channel widths 0.3 mm; Linear internal channel width 0.1 mm; Mixing chamber width (W) 1 mm; Depth 400 um; Mixing chamber length 25 mm;
xlvi. Outer channel widths 0.3 mm; Linear internal channel width 0.1 mm; Mixing chamber width (W) 1 mm; Depth 400 um; Mixing chamber length 50 mm;
xlvii. Outer channel widths 0.3 mm; Linear internal channel width 0.1 mm; Mixing chamber width (W) 1 mm; Depth 500 um; Mixing chamber length 25 mm;
xlviii. Outer channel widths 0.3 mm; Linear internal channel width 0.1 mm; Mixing chamber width (W) 1 mm; Depth 500 um; Mixing chamber length 50 mm;
xlix. Outer channel widths 0.2 mm; Linear internal channel width 0.2 mm; Mixing chamber width (W) 3 mm; Depth 400 um; Mixing chamber length 25 mm;
l. Outer channel widths 0.2 mm; Linear internal channel width 0.2 mm; Mixing chamber width (W) 3 mm; Depth 400 um; Mixing chamber length 50 mm;
li. Outer channel widths 0.2 mm; Linear internal channel width 0.2 mm; Mixing chamber width (W) 3 mm; Depth 500 um; Mixing chamber length 25 mm;
lii. Outer channel widths 0.2 mm; Linear internal channel width 0.2 mm; Mixing chamber width (W) 3 mm; Depth 500 um; Mixing chamber length 50 mm;
liii. Outer channel widths 0.2 mm; Linear internal channel width 0.2 mm; Mixing chamber width (W) 2 mm; Depth 400 um; Mixing chamber length 25 mm;
liv. Outer channel widths 0.2 mm; Linear internal channel width 0.2 mm; Mixing chamber width (W) 2 mm; Depth 400 um; Mixing chamber length 50 mm;
lv. Outer channel widths 0.2 mm; Linear internal channel width 0.2 mm; Mixing chamber width (W) 2 mm; Depth 500 um; Mixing chamber length 25 mm;
lvi. Outer channel widths 0.2 mm; Linear internal channel width 0.2 mm; Mixing chamber width (W) 2 mm; Depth 500 um; Mixing chamber length 50 mm;
lvii. Outer channel widths 0.2 mm; Linear internal channel width 0.2 mm; Mixing chamber width (W) 1 mm; Depth 400 um; Mixing chamber length 25 mm;
lviii. Outer channel widths 0.2 mm; Linear internal channel width 0.2 mm; Mixing chamber width (W) 1 mm; Depth 400 um; Mixing chamber length 50 mm;
lix. Outer channel widths 0.2 mm; Linear internal channel width 0.2 mm; Mixing chamber width (W) 1 mm; Depth 500 um; Mixing chamber length 25 mm;
lx. Outer channel widths 0.2 mm; Linear internal channel width 0.2 mm; Mixing chamber width (W) 1 mm; Depth 500 um; Mixing chamber length 50 mm;
lxi. Outer channel widths 0.2 mm; Linear internal channel width 0.1 mm; Mixing chamber width (W) 3 mm; Depth 400 um; Mixing chamber length 25 mm;
lxii. Outer channel widths 0.2 mm; Linear internal channel width 0.1 mm; Mixing chamber width (W) 3 mm; Depth 400 um; Mixing chamber length 50 mm;
lxiii. Outer channel widths 0.2 mm; Linear internal channel width 0.1 mm; Mixing chamber width (W) 3 mm; Depth 500 um; Mixing chamber length 25 mm;
lxiv. Outer channel widths 0.2 mm; Linear internal channel width 0.1 mm; Mixing chamber width (W) 3 mm; Depth 500 um; Mixing chamber length 50 mm;
lxv. Outer channel widths 0.2 mm; Linear internal channel width 0.1 mm; Mixing chamber width (W) 2 mm; Depth 400 um; Mixing chamber length 25 mm;
lxvi. Outer channel widths 0.2 mm; Linear internal channel width 0.1 mm; Mixing chamber width (W) 2 mm; Depth 400 um; Mixing chamber length 50 mm;
lxvii. Outer channel widths 0.2 mm; Linear internal channel width 0.1 mm; Mixing chamber width (W) 2 mm; Depth 500 um; Mixing chamber length 25 mm;
lxviii. Outer channel widths 0.2 mm; Linear internal channel width 0.1 mm; Mixing chamber width (W) 2 mm; Depth 500 um; Mixing chamber length 50 mm;
lxix. Outer channel widths 0.2 mm; Linear internal channel width 0.1 mm; Mixing chamber width (W) 1 mm; Depth 400 um; Mixing chamber length 25 mm;
lxx. Outer channel widths 0.2 mm; Linear internal channel width 0.1 mm; Mixing chamber width (W) 1 mm; Depth 400 um; Mixing chamber length 50 mm;
lxxi. Outer channel widths 0.2 mm; Linear internal channel width 0.1 mm; Mixing chamber width (W) 1 mm; Depth 500 um; Mixing chamber length 25 mm;
lxxii. Outer channel widths 0.2 mm; Linear internal channel width 0.1 mm; Mixing chamber width (W) 1 mm; Depth 500 um; Mixing chamber length 50 mm.

Further specific embodiments of microfluidic devices of the present invention are based on the following dimensions (tolerances indicated by ±) in Table 1:

| | Mixing | Mixing | Outer | Internal | |
|---|---|---|---|---|---|
| | Chamber | Chamber | Channels | Channel | Channel |
| Embodi- | Width | Length | Width | Width | Depth |
| ment | (μm) | (mm) | (μm) | (μm) | (μm) |
| 1 | 2000 ± 100 | 25 | 200 ± 20 | 400 ± 40 | 400 ± 40 |
| 2 | 2000 ± 100 | 25 | 400 ± 40 | 200 ± 20 | 400 ± 40 |
| 3 | 1600 ± 100 | 25 | 200 ± 20 | 400 ± 40 | 400 ± 40 |
| 4 | 1000 ± 100 | 25 | 100 ± 10 | 270 ± 27 | 400 ± 40 |
| 5 | 1800 ± 100 | 25 | 100 ± 10 | 230 ± 23 | 400 ± 40 |
| 6 | 1600 ± 100 | 25 | 150 ± 15 | 200 ± 20 | 400 ± 40 |
| 7 | 1600 ± 100 | 50 | 200 ± 20 | 400 ± 40 | 400 ± 40 |
| 8 | 1600 ± 100 | 50 | 400 ± 40 | 200 ± 20 | 400 ± 40 |
| 9 | 1600 ± 100 | 25 | 400 ± 40 | 700 ± 70 | 400 ± 40 |
| 10 | 1600 ± 100 | 25 | 400 ± 40 | 700 ± 70 | 400 ± 40 |
| (Tapered) | (start from | | | | |
| | 1600, end at | | | | |
| | 500) | | | | |
| 11 | 2000 ± 100 | 25 | 200 ± 20 | 400 ± 40 | 500 ± 40 |
| 12 | 2000 ± 100 | 25 | 400 ± 40 | 200 ± 20 | 500 ± 40 |
| 13 | 1600 ± 100 | 25 | 200 ± 20 | 400 ± 40 | 500 ± 40 |
| 14 | 1000 ± 100 | 25 | 100 ± 10 | 270 ± 27 | 500 ± 40 |
| 15 | 1800 ± 100 | 25 | 100 ± 10 | 230 ± 23 | 500 ± 40 |
| 16 | 1600 ± 100 | 25 | 150 ± 15 | 200 ± 20 | 500 ± 40 |
| 17 | 1600 ± 100 | 50 | 200 ± 20 | 400 ± 40 | 500 ± 40 |
| 18 | 1600 ± 100 | 50 | 400 ± 40 | 200 ± 20 | 500 ± 40 |
| 19 | 1600 ± 100 | 25 | 400 ± 40 | 700 ± 70 | 500 ± 40 |
| 20 | 1600 ± 100 | 25 | 400 ± 40 | 700 ± 70 | 500 ± 40 |
| (Tapered) | (start from | | | | |
| | 1600, end at | | | | |
| | 500) | | | | |

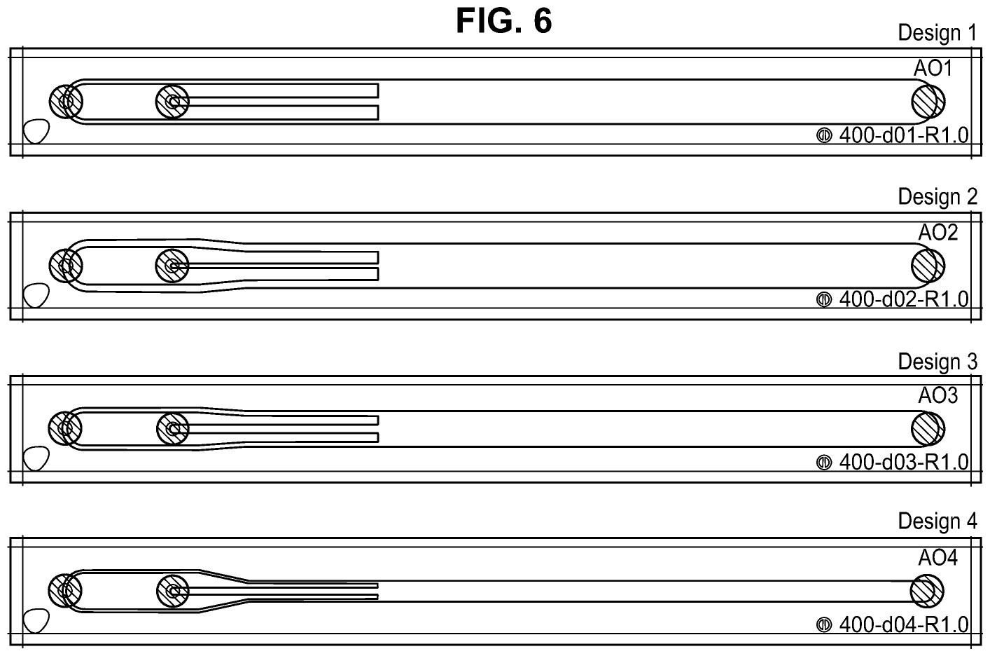

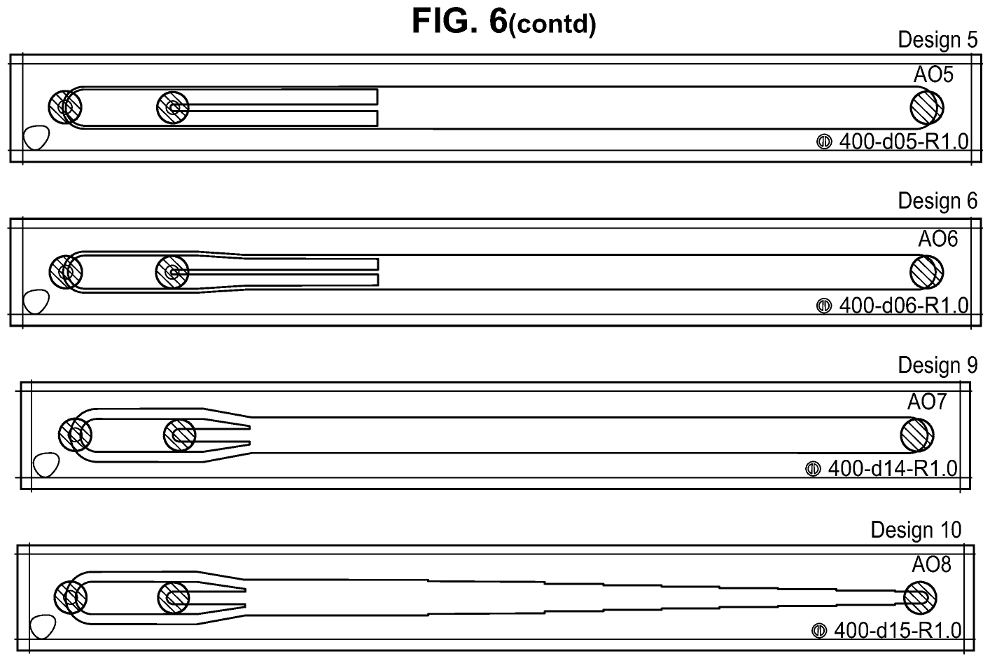

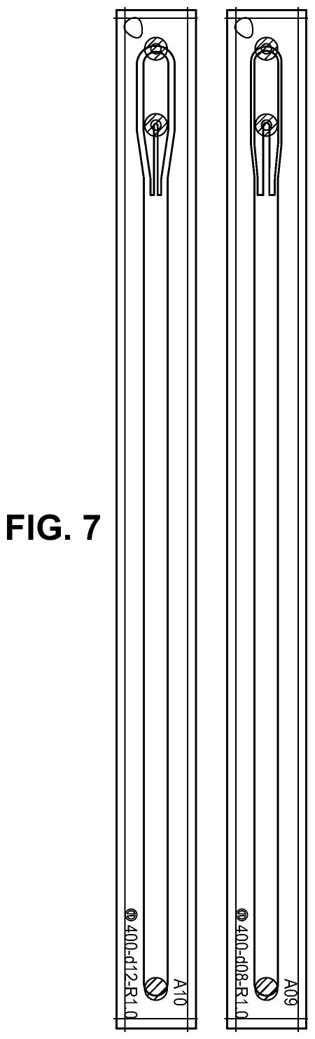

FIGS. 6 and 7 provide schematics of each of the embodiments that are produced with channels having either a depth of 400 μm or 500 μm.

By the term ‘substantially’ or ‘about’ in respect of a feature is meant functionally comparable, such that deviation may be tolerated if the essential nature of the feature is not changed. For example, in respect of specific values, the term ‘substantially’ or ‘about’ will typically mean a value within plus or minus 10 percent of the stated value.

### General Experimental Details

Single Mixing Chamber Microfluidic Device and General Operation: FIG. 1 illustrates the design of an exemplary microfluidic device having one mixing chamber on a single chip. The device comprises a mixing chamber of 2.5 cm in length and having an elongate cross-section of 2 mm by 0.4 mm. The mixing chamber has one centrally located inlet for the provision of the first solution and two inlets for the provision of the second solution. Each of the inlets is 0.2 mm wide and spans the full length of the other side of the mixing chamber. A single outlet is located at the distal end of the mixing chamber.

Operation: To perform microfluidic experiments, Cetoni neMesys Mi-pressure syringe pumps, Cetoni glass syringes and a Micronit chip-holder containing the device were placed in a temperature controlled area (Sartorius Certomat). Before any experimental runs, the system is cleaned and allowed to stabilize at the set temperature.

Product collection and solvent removal: The concentrated liposomes collected were divided into 2 parts: The first part was diluted with phosphate buffered saline (PBS) pH6.1 to reach a final concentration of 2 mg/ml DOPC and filtered on 0.22 um polyethersulfone (PES) membrane. Composition testing (DOPC, Cholesterol, 3D-MPL, QS-21) were performed on this sample. The second part was dialysed (Device 7000MWCO Thermo Slide-A-Lyser) with phosphate buffered saline pH6.1 to remove the organic solvent. The protocol used was: 2×15 min, 2×30 min and overnight (1L of PBS pH6.1 buffer at each time point). The retentate was then diluted to reach 2 mg/ml DOPC and filtered on 0.22 um PES membrane. Size measurements were undertaken on this sample. Residual alcohol was tested on this sample by gas chromatography.

### Example 1

PCT/EP2018/057488 discloses a microfluidic device comprising a serpentine central channel. The aim of the serpentine topography was to ensure that the length of the internal channel was the same as the external channels.

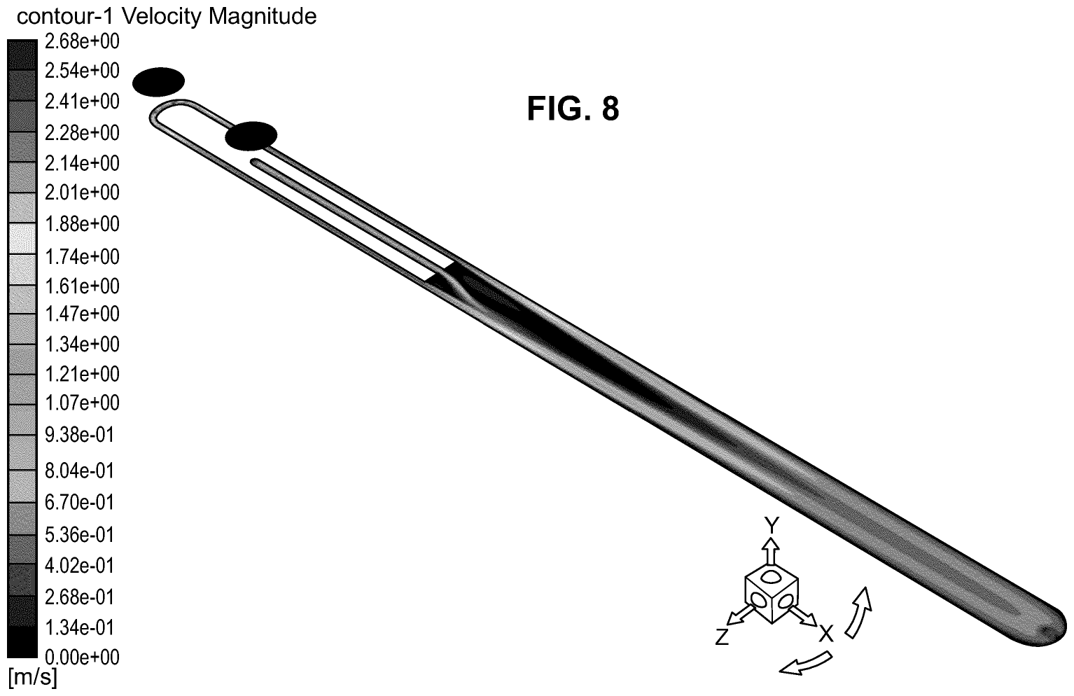

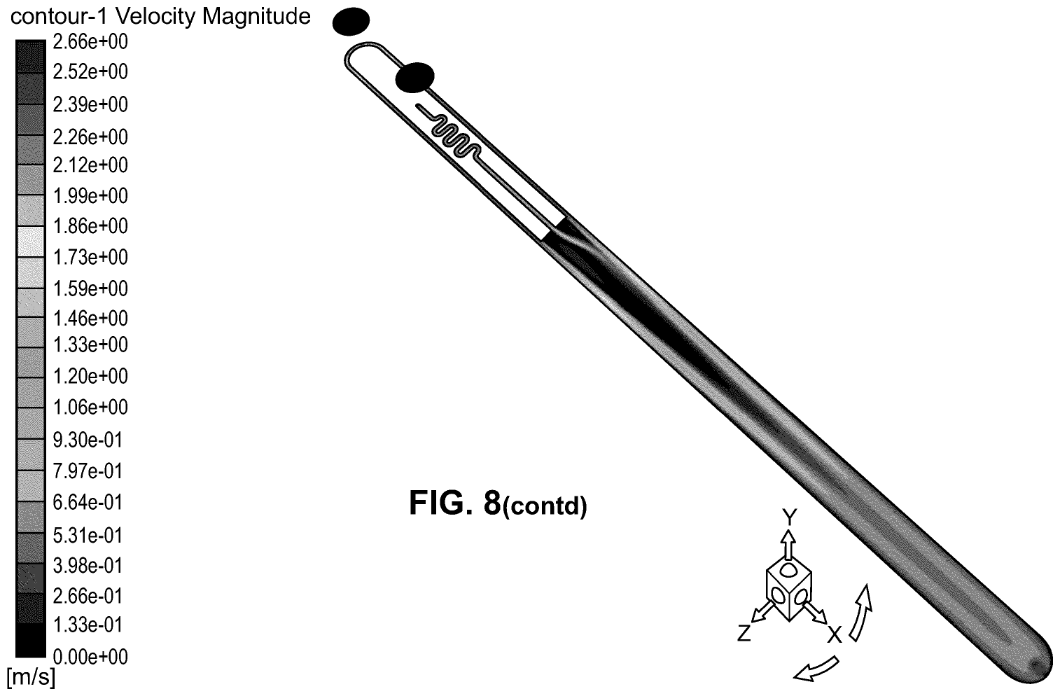

In a first experiment, computational fluid dynamics simulations were performed to investigate the impact of the central channel on fluid flow and to determine if a serpentine channel was necessary. FIG. 8 shows that replacing the serpentine channel with a linear central channel has no impact on fluid flow or mixing. The use of a linear central channel is advantageous for manufacturing.

### Example 2

Six microfluidic devices were prepared to investigate the effect of modifying channel width and mixing chamber width. One of the devices (Design 6) was modified to replace the conical inlet and outlet holes with cylindrical inlets and outlets:

| | External | Internal | Mixing | Mixing | | |
|---|---|---|---|---|---|---|
| | Channel | Channel | Chamber | Chamber | Channel | Serpentine |
| Design | Width | Width | Width | Length | Depth | Internal |
| No. | (mm) | (mm) | (mm) | (mm) | (mm) | Channel |
| 1 | 0.2 | 0.2 | 2 | 25 | 0.4 | YES |
| 2 | 0.2 | 0.2 | 2 | 25 | 0.4 | NO |
| 3 | 0.2 | 0.4 | 2 | 25 | 0.4 | NO |
| 4 | 0.4 | 0.2 | 2 | 25 | 0.4 | NO |
| 5 | 0.2 | 0.2 | 1.6 | 17.5 | 0.4 | NO |
| 6 | 0.2 | 0.2 | 2 | 25 | 0.4 | YES |

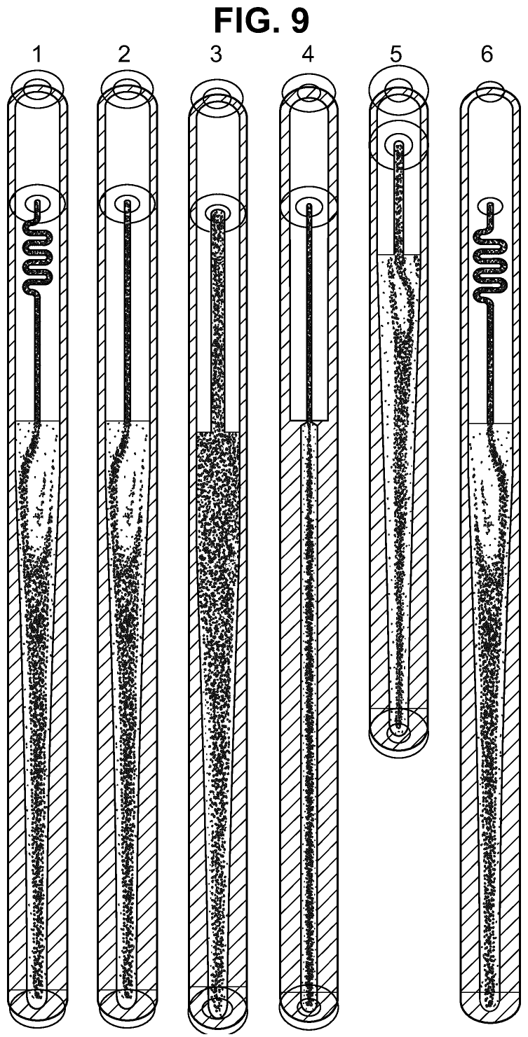

FIG. 9 shows the results of the computation fluid dynamics (CFD) simulations for each of the designs using the same flow rate and ratio (total 16 ml/min, 4:1 External/Internal channel).

As previously observed, the presence of the serpentine in the central capillary does not affect the profile compare to the same design without this serpentine. Increasing the width of the external channels (Design 4) resulted in a narrow distribution of the ink along the length of the microchip indicating that mixing was low.

Increasing the width of the central channel (design 3) resulted in a flow profile that was broader and more homogenous compared to the other designs tested. Changing the inlet and outlet to a cylindrical shape appeared to have little effect on the flow profile. Similarly, the design having a reduced mixing chamber width exhibited a flow profile similar to designs 1 and 2.

In order to compare mixing, Equation 1 was used to determine mixing performance for each design:

$$α = 1 - \sqrt{\frac{{σ}^{2}}{{σ}_{max}^{2}}}$$

$$with {σ}^{2} = \frac{1}{n} {{\sum }_{i = 1}}^{n} {( {C}_{i} - \overline{C} )}^{2} .$$

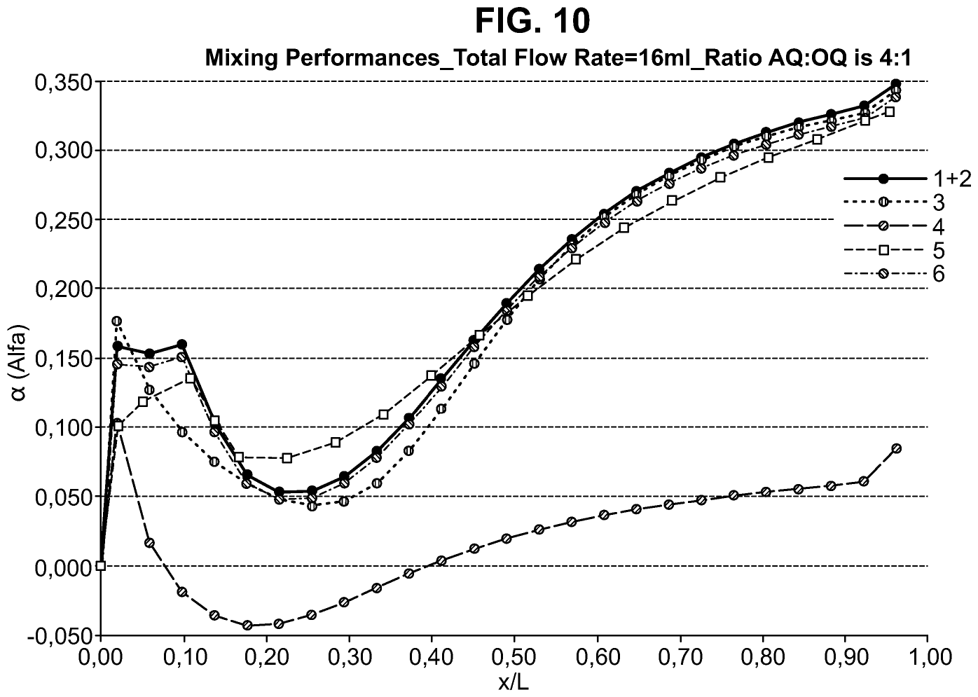

FIG. 10 shows a comparison of the mixing performance for each design (Note that the lines for designs 1 and 2 overlay precisely). The x axis corresponds to the ratio between the length of the central channel and the length of the mixing chamber to enable the different designs to be compared. These results confirmed the findings of the CFD simulations showing that increasing the width of the external channels resulted in reduced mixing of fluids entering the mixing chamber.

### Example 3

Based on the results obtained above, a further series of experiments was to determine which dimensions of the microchip geometry had the most impact on mixing performance. In these experiments, the width of the mixing chamber (MC) was either 1 mm, 2 mm or 3 mm; the width of the internal linear channel (CapInt) was either 0.1 mm, 0.2 mm or 0.3 mm; the width of the external channels (CapExt) was either 0.1 mm, 0.2 mm or 0.3 mm.

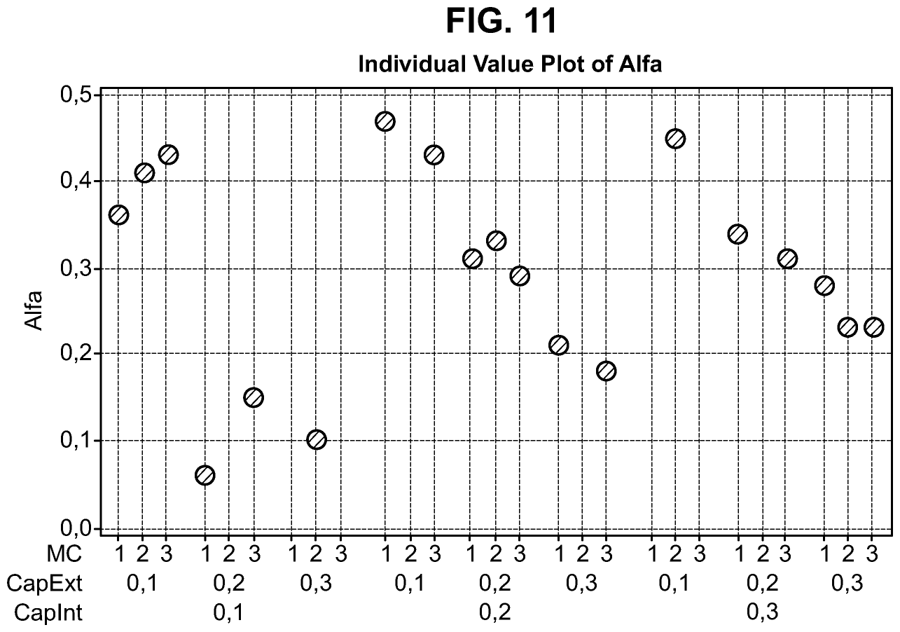

A final mixing coefficient (Alpha) was determined for each of these 19 different designs (FIG. 11). The highest value of alpha, i.e. best mixing performance, was obtained using a microfluidic device having a mixing chamber width of 1 mm, external channel width of 0.1 mm and internal channel width of 0.2 mm.

Surprisingly, mixing performance appeared to be mainly driven by the width of the external channels; mixing chamber width seemed to have less impact on the mixing.

### Example 4

The following model using only significant terms for mixing performance (alpha) was extracted:

$$alfa = {b}_{0} + \underbrace{{b}_{1} \cdot MC + {b}_{2} \cdot CapInt + {b}_{3} \cdot CapExt}_{Linear terms} + \underbrace{{b}_{4} \cdot {MC}^{2} + {b}_{5} \cdot {CapInt}^{2} + {b}_{6} \cdot {CapExt}^{2}}_{Quadratic terms} + \underbrace{{b}_{7} \cdot MC \cdot CapInt + {b}_{8} \cdot MC \cdot CapExt + {b}_{9} \cdot CapExt \cdot CapInt}_{2 \text{-} way interactions}$$

The model was used to determine geometries giving the best mixing coefficient using a stepwise or forward procedure.

The following table summarizes the best dimensions for mixing:

| | MC | CapInt | CapExt | Alfa Predicted |
|---|---|---|---|---|
| Stepwise model | 1 | 0.27 | 0.1 | 0.5 ± 0.1 |
| Forward model | 1.8 | 0.23 | 0.1 | 0.5 ± 0.1 |
| Best Bubble (best simulation) | 1 | 0.2 | 0.1 | 0.47 |

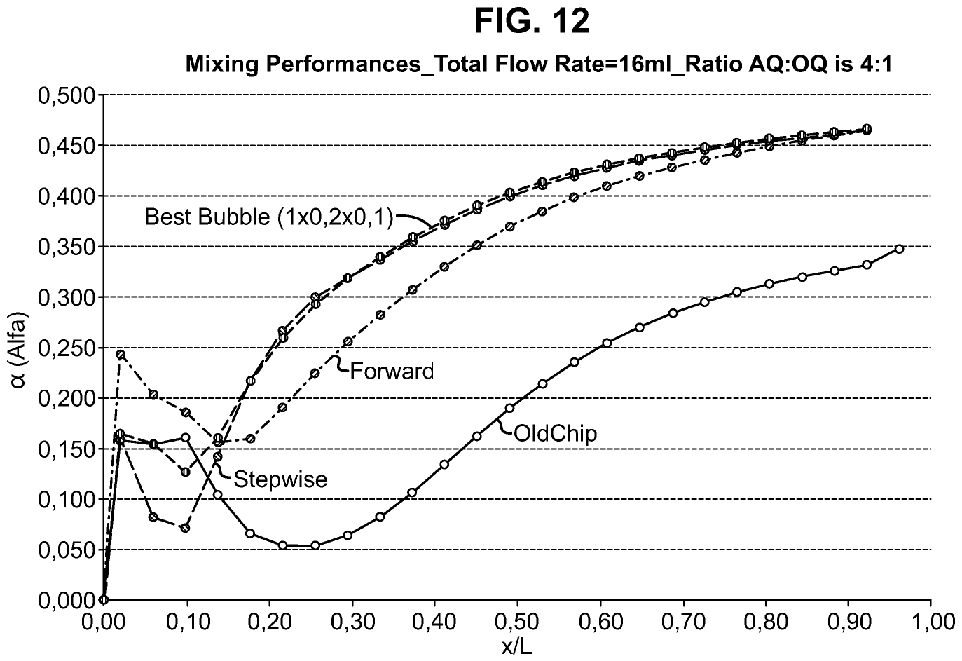

FIG. 12 shows a comparison of the mixing profile of the modified geometry in versus design 1. An increased mixing index has been achieved for the modified geometries compared to design 1 (from PCT/EP2018/057488).

### Example 5

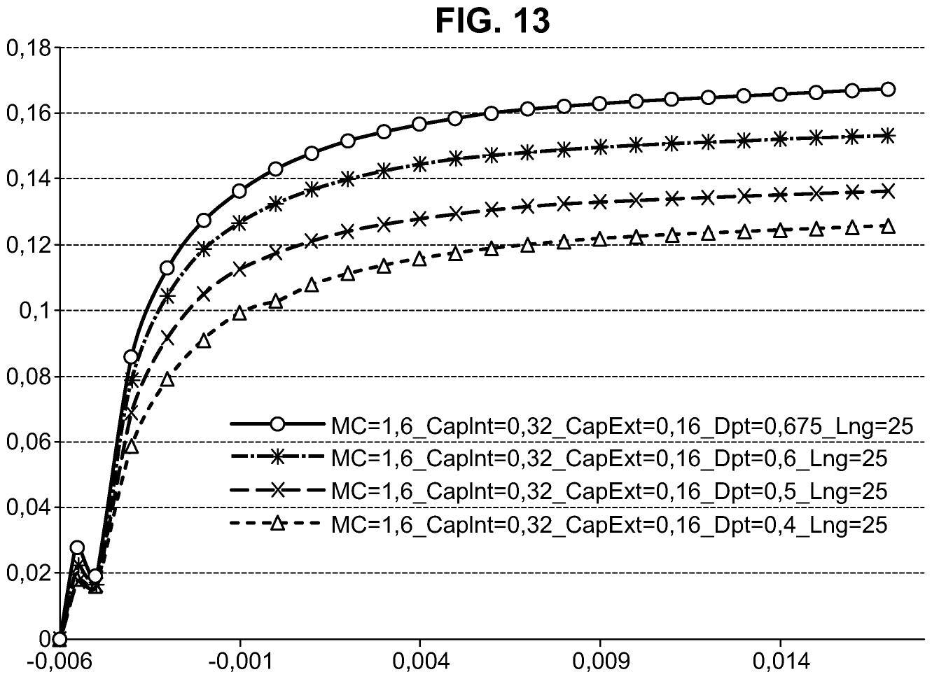

The impact of channel depth was investigated (FIG. 13). Simulations were performed using the same microchip geometry but varying the depth of the channel. Increases in channel depth appeared to improve mixing efficiency. However, the depth of the channels is dependent on the thickness of the substrate, in this case the silicon wafer. For a wafer 675 μm thick, the maximum depth should not be deeper than 500 μm.

### Example 6

Microfluidic chips of the following dimensions were produced with two depths: 400 μm and 500 μm:

| | Width | Width | Width | Length | |
|---|---|---|---|---|---|
| | mixing | External | Internal | mixing | |
| | chamber | channels | channel | chamber | |
| Design | (mm) | (mm) | (mm) | (mm) | Mixing |
| 1 | 2 | 0.2 | 0.4 | 25 | 0.1 |
| 2 | 2 | 0.4 | 0.2 | 25 | 0.05 |
| 3 | 1.6 | 0.2 | 0.4 | 25 | 0.1 |
| 4 | 1 | 0.1 | 0.27 | 25 | 0.22 |
| 5 | 1.8 | 0.1 | 0.23 | 25 | 0.26 |
| 6 | 1.6 | 0.15 | 0.2 | 25 | 0.16 |
| 8 | 1.6 | 0.2 | 0.4 | 50 | >0.1 |
| 12 | 1.6 | 0.4 | 0.2 | 50 | ? Very low |
| 14 | 1.6 | 0.4 | 0.7 | 25 | ? |
| 15 | 1.6 (Start from | 0.4 | 0.7 | 25 | ? |
| | 1.6 end at 0.75) | | | | |

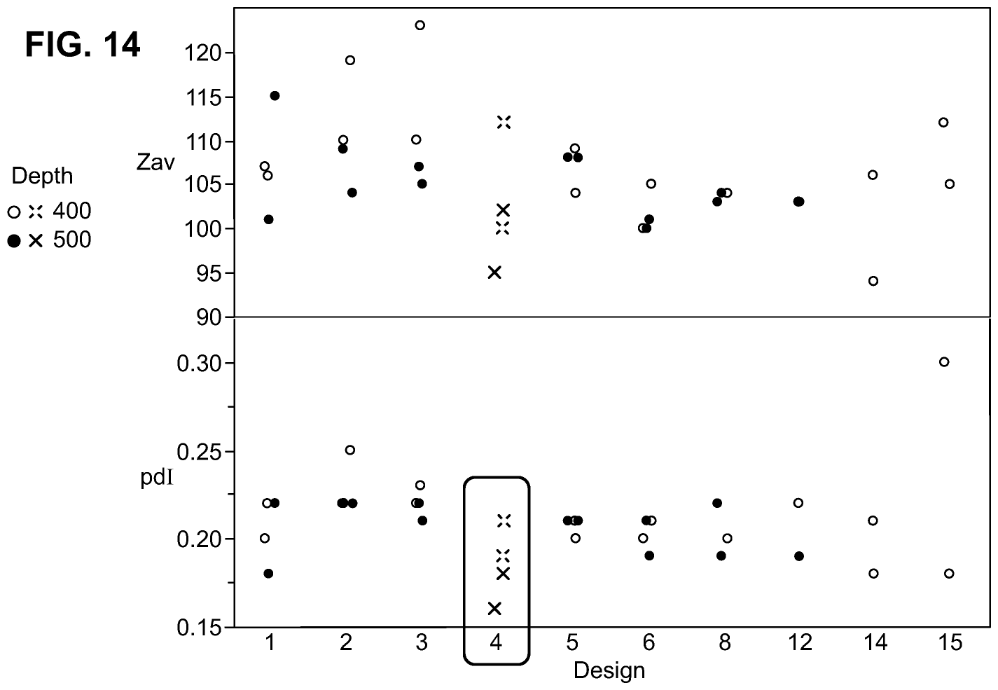

The results (size and PDI) were plotted for each microchip design, (FIG. 14) The microchip design 4 demonstrated a lower PDI when the depth is at 500 μm.

1-17. (canceled)

18. A microfluidic device comprising a mixing chamber having a distal end comprising an outlet region and a proximal end comprising an inlet region, the inlet region comprising two substantially parallel outer channels configured for transport of a first fluid and an inner channel configured for transport of a second fluid, wherein the inner channel is disposed between the two substantially parallel outer channels, and wherein the mixing chamber is configured to receive the first and second fluids from the inner and outer channels, and wherein the mixing chamber has rectangular cross-section with a long side 1600 μm±100 μm, a depth of 0.5 mm±40 μm, the width of the inner channel is 220 um to 500 um, the width of the two substantially parallel outer channels is about 150 μm or less.

19. The microfluidic device according to claim 18, wherein the mixing chamber has a uniform width from the proximal end to the distal end.

20. The microfluidic device according to claim 18, wherein the inner channel is linear.

21. The microfluidic device according to claim 20, wherein the width of the linear inner channel is about 270 μm.

22. The microfluidic device according to claim 18, wherein the mixing chamber has a uniform depth from the proximal end to the distal end.

23. The microfluidic device according to claim 18, wherein the width of the two substantially parallel outer channels is about 100 μm.

24. The microfluidic device according to claim 18, wherein the mixing chamber has a length of from about 20 mm to about 50 mm.

25. The microfluidic device according to claim 18, wherein the mixing chamber has a length of 25 mm.

26. The microfluidic device according to claim 18, wherein the two substantially parallel outer channels share a common inlet.

27. The microfluidic device according to claim 18, wherein the inner channel is disposed or positioned equidistant between the two substantially parallel outer channels.

28. The microfluidic device according to claim 18, wherein the inner channel is parallel with the two outer channels.

29. The microfluidic device according to claim 18, wherein the mixing chamber has a uniform depth from the proximal end to the distal end, wherein the inner channel is linear, the width of the linear inner channel is about 270 μm, the width of the two substantially parallel outer channels is about 100 μm, the mixing chamber has a length of from about 20 mm to about 50 mm, and the inner channel is disposed or positioned equidistant between the two substantially parallel outer channels.

30. A chip comprising a microfluidic device according to claim 18.

31. A chip comprising a microfluidic device according to claim 29.
